(19) United States
(12) Patent Application Publication
(10) Pub. No.: US 2006/0177708 A1
(43) Pub. Date: Aug. 10, 2006

(54) Fuel cell power system and operating method thereof

(76) Inventors: Toru Koyama, Hitachi (JP); Makoto Morishima, Hitachinaka (JP); Hidetoshi Honbou, Hitachinaka (JP); Kenichi Souma, Mito (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/346,329

(22) Filed: Feb. 3, 2006

(30) Foreign Application Priority Data
Feb. 4, 2005 (JP) 2005-029154

(51) Int. Cl. H01M 8/10

(52) U.S. Cl. 429/13; 429/30; 429/33

(57) ABSTRACT

It is an object to provide a fuel cell power system which can produce an output stably for extended periods without sensing or estimating and controlling fuel concentration. The fuel cell power system is equipped with a plurality of electrically connected single cells running on a liquid fuel, each having an anode for oxidizing a fuel supplied to the cells and cathode for reducing oxygen with an electrolyte membrane in-between, wherein the fuel concentration is kept at a constant level by virtue of well balanced associated water, fuel cross-over and the like to produce an output stably for extended periods when the electrolyte membrane has a liquid fuel permeability of 70 mA/cm² or less and a make-up liquid fuel has a concentration of 15% by weight or more.

### FIELD OF THE INVENTION

The present invention relates to a fuel cell power system equipped with a plurality of electrically connected single cells, each having an anode and having a cathode with an electrolyte membrane between the anode and the cathode, to generate a power with a liquid fuel, e.g., methanol, dimethyl ether or ethylene glycol, and a method for operating the same. The present invention is suitable as a compact, portable fuel cell system.

### BACKGROUND OF THE INVENTION

Portable electronic devices, e.g., cellular phones, laptop computers, audio-visual devices or mobile information terminals, have been rapidly spreading in tandem with the electronic technology advances, which make them compacter. These portable electronic devices have been driven by a secondary battery, which must be charged after discharging a certain amount of power and hence involves problems of needing a charging device and relatively long charging time.

More recently, use of a fuel cell as a power source for portable electronic devices has been considered. A fuel cell electrochemically converts chemical energy of a fuel directly into electrical energy. It needs no motive energy section, and is highly realizable as a compact power-generating device. Moreover, it can continuously generate power without stopping the service by only exchanging or replenishing a fuel, unlike a secondary battery, which is stopped temporarily while being charged.

Polymer electrolyte fuel cells (PEFCs) of high output density have been in development as fuel cells for portable electronic devices. A PEFC uses an electrolyte membrane of perfluorocarbon sulfonic acid resin to oxidize hydrogen gas at the anode and reduce oxygen at the cathode. However, it is unsuitable for compact devices, because it uses hydrogen gas of low volumetric energy density as a fuel, which increases size of the fuel tank. By contrast, a liquid fuel is more advantageous than a gas fuel for fuel cells for compact devices, because of its higher density. Therefore, methanol, ethanol, propanol, dimethyl ether, ethylene glycol or the like is a promising liquid fuel for a fuel cell as a power source for compact electronic devices serviceable for extended periods. One of the known methanol-firing fuel cells uses an electrolyte membrane of sulfonated polyether sulfone resin and supplies a fuel of 20% by weight methanol solution by a siphon effect (see, e.g., JP-A-2003-323904).

### BRIEF SUMMARY OF THE INVENTION

A liquid-firing fuel cell power source is described by taking, as an example, a standard direct methanol fuel cell (DMFC). A DMFC dissociates an aqueous methanol solution, supplied to an anode catalyst layer, into carbon dioxide, hydrogen ion and electron (Formula (1)).
CH₂OH+H₂O→CO₂+6H⁺+6e⁻ (1)

The hydrogen ion thus produced moves from the anode to the cathode side, to react on a cathode catalyst layer with oxygen gas diffusing from ambient air and also with the electron on the cathode catalyst layer to produce water (Formula (2)).
6H⁺+3/2O₂+6e⁻→3H₂O (2)

As a net, the overall chemical reaction is reduced to oxidation of methanol with oxygen to produce carbon dioxide gas and water (Formula (3)), and the chemical reaction is the same in form as that involved in flaming combustion of methanol.
CH₃OH+3/2O₂→CO₂+3H₂O (3)

A fuel cell with an aqueous methanol solution as a fuel generates power by converting chemical energy of methanol directly into electrical energy by the electrochemical reaction described above. However, few DMFCs totally consume an aqueous methanol solution supplied on the anode, part of the methanol solution being discharged to the outside. Therefore, utilization factor of the solution is generally low. Returning the solution discharged from the cell back to a solution tank is considered. This, however, gradually dilutes the solution in the tank, because methanol is consumed with equimolar water in the anode catalyst layer, causing problems of methanol shortage within the cell and sharply decreased electromotive force.

One approach for solving these problems is controlling an aqueous methanol solution concentration at a given level by sensing the concentration.

It is an object of the present invention to provide a power system for liquid-firing fuel cells, which can stably produce power for extended periods by keeping the liquid fuel composition at a constant level.

The inventors of the present invention have studied in detail causes for changed concentration of liquid fuel for fuel cells to simplify mechanisms for controlling liquid fuel concentration, achieving the present invention. As a result, the four major causes are identified; consumption of fuel and water on the anode for power generation according to Formula (1), water associated with movement of H+ from the anode to the cathode, fuel cross-over and water cross-over.

Consumption of fuel and water on the anode for power generation according to Formula (1), occurring only in the power generation process of a fuel cell, is an essential phenomenon for power generation, and the consumption can be estimated from power output. Production of water associated with movement of H+ from the anode to the cathode, occurring only in the power generation process of a fuel cell, is also an essential phenomenon for power generation. The associated water production can be also estimated from power output, when dependences of moved hydrated proton (associated water) on temperature and fuel concentration are predetermined. Fuel cross-over occurs when a liquid fuel is in contact with a polymer electrolyte membrane and is, as it were, a phenomenon equivalent to self-discharge of a cell. Amount of cross-over liquid is difficult to estimate simply by calculation, because it depends on various factors, e.g., electrolyte membrane material and thickness, fuel concentration and temperature, and liquid fuel and air (oxygen) supplies. Water cross-over, on the other hand, is negligibly small.

The inventors of the present invention have found, after having studied these causes in detail, that a liquid fuel can have an essentially constant concentration of 15 to 20% by weight after a lapse of certain time to produce a stable output without a mechanism of estimating and controlling liquid fuel concentration in a fuel cell, when an electrolyte membrane having a make-up liquid fuel permeability of 70 mA/cm² or less, preferably 0.02 to 70 mA/cm², is used and make-up liquid fuel is kept at a concentration of 15% by weight or more. A liquid fuel having a concentration above 60% by weight is not desirable, because of accelerated cross-over to make the system inefficient.

It is also found that use of an electrolyte membrane having a make-up liquid fuel permeability of 70 mA/cm² or less, preferably 0.02 to 70 mA/cm², brings other favorable effects of reduced amount of steam/water production on the cathode and prevention of interrupted flow of oxygen only by natural aspiration without need of forced removal, recovery or the like of steam/water, to achieve stable operation. As a result, it removes adverse effects of steam/water on devices in which it is used, e.g., PDAs, personal computers and cellular phones.

As described above, the present invention provides a fuel cell power system equipped with a plurality of electrically connected single cells, each having an anode for oxidizing a liquid fuel supplied to the cells and cathode for reducing oxygen with an electrolyte membrane in-between, wherein the electrolyte membrane has a liquid fuel permeability of 0.02 to 70 mA/cm² and the liquid fuel having a concentration of 15% by weight or more is supplied to generate power.

The present invention also provides a method for operating a fuel cell power system equipped with a plurality of electrically connected single cells, each having an anode for oxidizing a liquid fuel supplied to the cells and cathode for reducing oxygen with an electrolyte membrane in-between to generate power, wherein the electrolyte membrane has a liquid fuel permeability of 0.02 to 70 mA/cm² and the liquid fuel having a concentration of 15 to 60% by weight is supplied.

The present invention also provides a fuel cell power system equipped with an anode and cathode with an electrolyte membrane in-between, holding a liquid fuel having a concentration of 90% by weight or more, mixing water produced on the cathode with the liquid fuel and having a liquid fuel supply system which continuously supplies the liquid fuel to the anode, wherein the electrolyte membrane has a liquid fuel permeability of 0.02 to 70 mA/cm².

The present invention also provides an electronic device having a fuel cell power system equipped with a plurality of electrically connected single cells, each running on a liquid fuel and having an anode for oxidizing the liquid fuel and cathode for reducing oxygen with an electrolyte membrane in-between, wherein the electrolyte membrane has a liquid fuel permeability of 0.02 to 70 mA/cm² and the liquid fuel having a concentration of 15% by weight or more is supplied to generate power.

Other objects, features and advantages of the invention will become apparent from the following description of the embodiments of the invention taken in conjunction with the accompanying drawings.

### BRIEF DESCRIPTION OF THE DRAWINGS

FIG. 1 structurally outlines the fuel cell power system of the present invention.

FIG. 2 presents a temporal change of methanol concentration in a DMFC power system with a built-in MEA (1).

FIG. 3 presents a temporal change of methanol concentration in a DMFC power system with a built-in MEA (2).

FIG. 4 presents a temporal change of methanol concentration in a DMFC power system with a built-in MEA (3).

FIG. 5 presents a temporal change of methanol concentration in a DMFC power system of COMPARATIVE EXAMPLE.

FIG. 6 presents a temporal change of methanol concentration in a DMFC power system of the present invention.

FIG. 7 presents a temporal change of methanol concentration in a DMFC power system with a built-in MEA (12).

FIG. 8 presents a temporal change of methanol concentration in a DMFC power system with a built-in MEA (13).

FIG. 9 presents a temporal change of methanol concentration in a DMFC power system with a built-in MEA (14).

FIG. 10 presents a temporal change of methanol concentration in a DMFC power system with a built-in MEA (15).

FIG. 11 presents a temporal change of methanol concentration in a DMFC power system with a built-in MEA (16).

FIG. 12 presents a temporal change of methanol concentration in a DMFC power system with a built-in MEA (17).

FIG. 13 presents a temporal change of methanol concentration in a DMFC power system with a built-in MEA (18).

FIG. 14 presents temporal changes of methanol concentration with varying initial concentrations.

FIG. 15 outlines one embodiment of fuel cell power system of the present invention.

FIG. 16 is an oblique view illustrating a cell structure for the fuel cell power system of the present invention.

FIG. 17 is an oblique view illustrating an external appearance of the fuel cell power system of the present invention, equipped with a cartridge holder.

FIG. 18 illustrates one embodiment of fuel chamber structure for the fuel cell power system of the present invention.

FIG. 19 illustrates one embodiment of gas exhaust module for the fuel cell power system of the present invention.

FIG. 20 illustrates one embodiment of fuel chamber/gas exhaust module assembly structure for the fuel cell power system of the present invention.

FIG. 21 illustrates one embodiment of anode terminal plate structure of for fuel cell power system of the present invention.

FIG. 22 illustrates one embodiment of cathode terminal plate structure for the fuel cell power system of the present invention.

FIG. 23 illustrates one embodiment of current collector/cathode terminal plate assembly structure for the fuel cell power system of the present invention.

FIG. 24 illustrates one embodiment of anode current collector structure for the fuel cell power system of the present invention.

FIG. 25 illustrates one embodiment of MEA structure and that of diffusion layer structure for the fuel cell power system of the present invention.

FIG. 26 illustrates one embodiment of gasket structure for the fuel cell power system of the present invention.

FIG. 27 is an oblique view illustrating an external appearance of one embodiment of fuel cell for which the fuel cell power system of the present invention is used.

FIG. 28 illustrates one embodiment of fuel chamber/anode terminal plate assembly in which an MEA is incorporated in the fuel cell power system of the present invention.

FIG. 29 illustrates one embodiment of cathode terminal plate structure, equipped with current collectors, for the fuel cell power system of the present invention.

FIG. 30 presents a temporal change of methanol concentration in the fuel cell power system of the present invention.

FIG. 31 illustrates one embodiment of portable information terminal structure in which the fuel cell power system of the present invention is used.

### DESCRIPTION OF REFERENCE NUMERALS

1: DMFC, 2: Polymer electrolyte membrane, 3: Anode catalyst layer, 4: Cathode catalyst layer, 5: Anode collector, 6: Cathode collector, 7: Air passage plate, 8: Air supply port, 9: Air exhaust, 10: Air passage, 11: Oxidant, 13: Fuel passage plate, 14: Fuel supply port, 15: Fuel exhaust, 16: Fuel passage, 17: Aqueous methanol solution container, 21: Water container, 23: Methanol solution container, 27: External circuit, 101: Fuel cell, 102: Fuel cartridge tank, 103: Output terminal, 104: Off-gas port, 105: DC/DC converter, 106: Controller, 107: Gasket, 111: MEA equipped with a diffusion layer, 112: Fuel chamber, 113a: Anode terminal plate, 113c: Cathode terminal plate, 114: Fuel cartridge holder, 115: Screw, 116: Connecting terminal, 201: Display, 202: Main board, 203: Antenna, 204: Hinge equipped with a cartridge holder, 205: Diaphragm, 206: Lithium ion secondary battery, 210: Box

### DETAILED DESCRIPTION OF THE INVENTION

The present invention secures an essentially constant liquid fuel concentration in a fuel cell after a lapse of certain time to produce a stable output without a mechanism of sensing or estimating and controlling liquid fuel concentration.

The present invention reduces amount of steam/water production on the cathode and prevents interrupted flow of oxygen only by natural aspiration without need of forced removal, recovery or the like of steam/water by use of an electrolyte membrane having a liquid fuel permeability of 0.02 to 70 mA/cm². As a result, it removes adverse effects of steam/water on devices in which it is used, e.g., PDAs, personal computers and cellular phones.

Electronic devices driven by a secondary battery, e.g., cellular phones, portable personal computers, portable audio and/or visual equipment, and other portable information terminals, can be serviceable for extended periods, when the fuel cell power system is incorporated as a battery charger. Moreover, it can work as a directly built-in power source for a device. Such a device is serviceable continuously by supplying a fuel to the cell.

The embodiments of the present invention are described in detail. The essential points of the present invention are use of an electrolyte membrane having a liquid fuel permeability of 70 mA/cm² or less, preferably 0.02 to 70 mA/cm², and keeping a liquid fuel concentration at 15% by weight or less. The electrolyte membrane is not limited for the present invention, so long as it has a liquid fuel permeability of 70 mA/cm² or less, preferably 0.02 to 70 mA/cm². The materials suitable for the electrolyte membrane include sulfonated engineering plastics, e.g., sulfonated polyetheretherketone, sulfonated polyether sulfone, sulfonated acrylonitrile-butadiene-styrene polymer, sulfonated polysulfide and sulfonated polyphenylene; sulfoalkylated engineering plastics, e.g., sulfoalkylated polyetheretherketone, sulfoalkylated polyether sulfone, sulfoalkylated polyetherether sulfone, sulfoalkylated polysulfone, sulfoalkylated polysulfide and sulfoalkylated polyphenylene; and hydrocarbon-based ones, e.g., sulfoalkyletherified polyphenylene. Of these, sulfoalkylated hydrocarbon-based ones and sulfoalkyletherified hydrocarbon-based ones are more preferable viewed from their liquid fuel permeability, ion conductivity, swelling characteristics, among others. The fuel cell is serviceable at a higher temperature range by incorporating a composite electrolyte membrane or the like with a proton-conductive inorganic material dispersed microscopically in a heat-resistant resin. These inorganic materials include tungsten oxide hydrate, zirconium oxide hydrate, tin oxide hydrate, silicotungsten acid, silicomolybdenum acid, tungstophosphoric acid and molybdenum acid. An acidic electrolyte membrane of the above-described hydrate is generally swollen and deformed, and may have an insufficient mechanical strength when it is highly ion-conductive. In such a case, the membrane is preferably reinforced with a non-woven or woven fabric of fibers of high mechanical strength, durability and heat resistance as a core, or as a filler to be incorporated in the membrane production step. The membrane can have a reduced liquid fuel permeability, when it is made of a polybenzimidazole doped with sulfuric, phosphoric, sulfonic or phosphinic acid. The polymer electrolyte membrane for the present invention may be incorporated with an additive for common polymers, e.g., plasticizer, stabilizer or releasing agent, within limits not harmful to the object of the present invention.

The polymer electrolyte membrane contains sulfonic acid at 0.5 to 2.0 milliequivalents (meq)/g-dry resin, preferably 0.8 to 1.5 milliequivalents/g-dry resin. The content outside of the above range is not desirable. At lower than 0.5 milliequivalents/g-dry resin, the membrane will have an excessive ion-conducting resistance. At higher than 2.0 milliequivalents/g-dry resin, on the other hand, the membrane tends to be dissolved in an aqueous fuel solution, e.g., methanol solution. Thickness of the polymer electrolyte membrane is not limited, but preferably in a range from 10 to 300 μm, particularly preferably 15 to 200 μm. It is preferably thicker than 10 μm for securing a sufficiently high practical strength, and thinner than 200 μm for reducing membrane resistance, i.e., for improving power-generating capacity. When the membrane is produced by solution casting, its thickness can be controlled by solution concentration or thickness of the solution film formed on a base film. When it is formed from a molten state, its thickness can be controlled by drawing the film of a given thickness formed by pressing or extrusion at a given drawing ratio.

An electrode for an MEA to be assembled in a DMFC is composed of an electroconductive material impregnated with fine catalyst metal particles. It may be incorporated with a water repellent agent or binder, as required. Moreover, a layer of electroconductive material, free of catalyst and incorporated with a water repellent agent or binder as required, may be formed on a catalyst layer. Any catalyst metal may be used for the electrode, so long as it can promote oxidation of a liquid fuel and reduction of oxygen. The catalyst metal useful for the present invention include platinum, gold, silver, palladium, iridium, rhodium, ruthenium, iron, cobalt, nickel, chromium, tungsten, manganese, vanadium, titanium and an alloy thereof, of which platinum in particular is used in many cases. The catalyst metal has a particle size normally in a range from 10 to 30 Å. It is advantageous costwise to deposit the metal on a carrier, e.g., carbon, preferably to 0.01 to 10 mg/cm² in a condition after the electrode is formed, because of reduced catalyst requirement.

Any method can be used for joining a fuel cell electrolyte membrane to an electrode, and may be selected from known ones. An MEA can be produced by assembling an electrolyte membrane by hot pressing with a catalyst layer which is formed by spreading and heat-treating a suspension of carbon-supported platinum catalyst particles and polytetrafluoroethylene on paper-shaped carbon, after the catalyst layer is coated with a binder of electrolyte solution of the same material as the electrolyte membrane or fluorine-based electrolyte. The other useful methods include coating platinum catalyst particles with an electrolyte solution of the same material as the electrolyte membrane, printing a catalyst paste, spreading a catalyst on an electrolyte membrane by spraying or ink jetting, electrolessly plating an electrode on an electrolyte membrane, and adsorbing and later reducing a complex ion of platinum group metal on an electrolyte membrane. Of these, spreading a catalyst paste by ink jetting on an electrolyte membrane is more advantageous, because of reduced catalyst loss.

Any electroconductive material can be used for the present invention, so long as it is electron-conductive. These materials include various metals, and carbonaceous materials, e.g., carbon black (e.g., furnace black, channel black and acetylene black), activated coal and graphite. They may be used either individually or in combination. Water repellent agents useful for the present invention include fluorinated carbon. The binder for the present invention is preferably in the form of solution of hydrocarbon-based electrolyte similar to that for the electrolyte membrane, viewed from adhesiveness. However, it may be selected from various resins. It may be incorporated with a fluorine-containing resin having water repellent capacity, e.g., polytetrafluoroethylene, tetrafluoroethylene/perfluoroalkyl vinyl ether copolymer or tetrafluoroethylene/hexafluoropropylene copolymer.

A DMFC is composed of a plurality of single cells stacked via a cooling plate or the like, where each single cell comprises a grooved fuel and oxidant distributor plates formed on the MEA assembled by the above-described procedure, each plate working as a fuel or oxidant passage and current collector. However, the connecting method is not limited. For example, the single cells may be connected to each other on a two-dimensional plane, instead of being stacked.

Working temperature of fuel cell is not limited, although it is preferably higher for enhanced electrode catalyst activity and reduced electrode over-voltage. The cell can operate after evaporating the liquid fuel.

A plurality of single cells, each comprising an anode, electrolyte membrane and cathode, when connected to each other in series by electroconductive interconnections, can produce a higher voltage. The present invention can realize a compact power source serviceable for extended periods to continuously generate power by use of a liquid fuel, e.g., aqueous solution of methanol, of high volumetric energy density without needing an auxiliary device, e.g., that for forced supply of fuel or oxidant, or for forced cell cooling. It is built in various devices, e.g., cellular phones, laptop personal computers and portable video cameras to drive them continuously for extended periods, when supplied with a given fuel as required. It is an effective approach to greatly reduce frequency of fuel supply in the above case by combining the compact power source with a charger for a cellular phone, laptop personal computer or portable video camera driven by a secondary battery. In this case, it is built in a device-containing case to work as a battery charger. The portable electronic device, when it is to be used, is driven by the secondary battery after being taken out of the case and, when it is not used, contained in the case, where the built-in compact power source charges the secondary battery to which it is connected via the charger. This allows to increase fuel tank capacity thereby greatly reducing frequency of fuel supply.

The present invention is described in more detail by EXAMPLES. It is however to be understood that the present invention is not limited to .these examples.

### EXAMPLE 1

(1) Synthesis of Chloromethylated Polyether Sulfone

A 500 mL four-mouthed, round-bottomed flask, equipped with a stirrer, thermometer, calcium chloride tube and reflux condenser, was charged with 30 g of polyether sulfone (PES), 250 mL of tetrachloroethane and then 40 mL of chloromethylmethyl ether, after it was purged with nitrogen, to which a mixed solution of 1 mL of anhydrous tin (IV) chloride and 20 mL of tetrachloroethane was added dropwise, and the mixture was heated at 80° C. for 90 minutes with stirring. Then, the resulting reaction solution was thrown into 1 L of methanol, to separate out the polymer produced. The separated precipitate was crushed by a mixer and washed with methanol to prepare chloromethylated polyether sulfone. It had a chloromethyl group introduction rate (ratio of structural units with introduced chloromethyl group to the total structural units in the compound of Chemical Formula (1), i.e., sum of “x” and “y”) of 36%, as confirmed by a nuclear magnetic resonance spectral analysis. 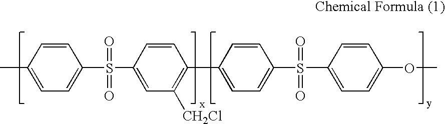
(2) Synthesis of Acetylthio(Polyether Sulfone)

A 1000 mL four-mouthed, round-bottomed flask, equipped with a stirrer, thermometer, calcium chloride tube and reflux condenser, was charged with the chloromethylated polyether sulfone prepared above, to which 600 mL of N-methylpyrrolidone (NMP) was added. Then, a solution of 9 g of potassium thioacetate dissolved in 50 mL of NMP was added, and the mixture was heated at 80° C. for 3 hours with stirring. The resulting reaction solution was thrown into 1 L of water, to separate out the polymer produced. The separated precipitate was crushed by a mixer and washed with water and dried under heating to prepare 32 g of acetylthio(polyether sulfone).

(3) Synthesis of Sulfomethylated Polyether Sulfone

A 500 mL four-mouthed, round-bottomed flask, equipped with a stirrer, thermometer, calcium chloride tube and reflux condenser, was charged with 20 g of the acetylthio(polyether sulfone) prepared above, and further with 300 mL of acetic acid and 20 mL of hydrogen peroxide solution. The mixture was heated at 45° C. for 4 hours with stirring. Then, the resulting reaction solution was put in 1 L of 6N aqueous solution of sodium hydroxide while it was being cooled, and stirred for a while. The resulting polymer was separated by filtration, and washed with water until the alkaline component was removed. Then, the polymer was added to 300 mL of 1N hydrochloric acid, and the mixture was stirred for a while. The polymer was separated by filtration, washed with water until the acidic component was removed and dried under a vacuum to quantitatively prepare 20 g of sulfomethylated polyether sulfone. Presence of sulfomethyl group was confirmed, because the chemical shift of NMR-determined methylene proton was shifted to 3.78 ppm. The product had a sulfomethyl group introduction rate (ratio of structural units with introduced sulfomethyl group to the total structural units in the compound of Chemical Formula (2), i.e., sum of “x” and “y”) of 36%, based on chloromethyl introduction rate of 36%. 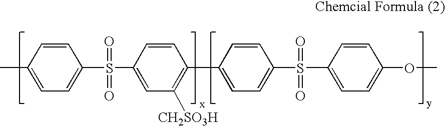
(4) Preparation of Electrolyte Membrane

The sulfomethylated polyether sulfone prepared in (3) above was dissolved in a (50/50) mixed solvent of dimethylacetoamide and methoxy ethanol to 5% by weight. The solution was developed on glass by spin coating, dried in air and then dried at 80° C. under a vacuum, to form a 42 μm thick electrolyte membrane of sulfomethylated polyether sulfone. It had a methanol permeability of 12 mA/cm² and ion conductivity of 0.053 S/cm at room temperature.

(5) Preparation of Membrane Electrode Assemblies (MEAs)

Preparation of MEA (1)

A carbon carrier impregnated with fine catalyst particles of platinum/ruthenium alloy (50/50 by atom) at 50% by weight was slurried with a 30% by weight solution of the sulfomethylated polyether sulfone prepared in (3) above dissolved in a mixed solvent of 1-propanol, 2-propanol and methoxy ethanol. The slurry was spread on a polyimide film to form an about 30 μm thick catalyst layer by screen printing, to prepare a porous anode film. Next, a carbon carrier impregnated with fine catalyst particles of platinum at 30% by weight was slurried with a mixed water/alcohol solvent containing a binder composed of the sulfomethylated polyether sulfone prepared in (3) above dissolved in a mixed solvent of 1-propanol, 2-propanol and methoxy ethanol. The slurry was spread on a polyimide film to form an about 10 μm thick catalyst layer by screen printing, to prepare a porous cathode film. The porous anode and cathode films were cut into 10 mm wide, 20 mm long shapes, to prepare the anode and cathode. About 0.5 mL of a 5% by weight solution of the sulfomethylated polyether sulfone prepared in (3) above dissolved in a mixed solvent of 1-propanol, 2-propanol and methoxy ethanol was penetrated into the anode surface. Then, the surface-treated anode was bonded to the power-generation section of the electrolyte membrane of sulfomethylated polyether sulfone prepared in (4) above, cut into a 16 mm wide, 33 mm long shape, and dried at 80° C. for 3 hours under a load of about 1 kg. Next, about 0.5 mL of a 5% by weight solution of the sulfomethylated polyether sulfone prepared in (3) above dissolved in a mixed solvent of 1-propanol, 2-propanol and methoxy ethanol was penetrated into the cathode surface. Then, the surface-treated cathode was bonded to the electrolyte membrane in such a way to lap over the anode layer prepared above, and dried at 80° C. for 3 hours under a load of about 1 kg, to prepare an MEA (1).

Preparation of MEA (2)

A porous anode film was prepared in the same manner as that for the MEA (1). For preparation of a porous cathode layer, a carbon carrier impregnated with fine catalyst particles of platinum at 30% by weight was slurried with a mixed water/alcohol solvent containing an electrolytic binder composed of 30% by weight perfluorocarbon sulfonic acid (Nafion 117, trade name, DuPont), and the slurry was spread on a polyimide film to form an about 10 μm thick catalyst layer by screen printing. The porous anode and cathode films were cut into 10 mm wide, 20 mm long shapes, to prepare the anode and cathode. About 0.5 mL of a 5% by weight solution of the sulfomethylated polyether sulfone prepared in (3) above dissolved in a mixed solvent of 1-propanol, 2-propanol and methoxy ethanol was penetrated into the anode surface. Then, the surface-treated anode was bonded to the power-generation section of the electrolyte membrane of sulfomethylated polyether sulfone prepared in (4) above, cut into a 16 mm wide, 33 mm long shape, and dried at 80° C. for 3 hours under a load of about 1 kg. Next, about 0.5 mL of a 5% by weight solution of Nafion 117 dissolved in a mixed solvent of water, isopropanol and normal propanol (20/40/40 by weight, Fluka Chemika) was penetrated into the cathode surface. Then, the surface-treated cathode was bonded to the electrolyte membrane in such a way to lap over the anode layer prepared above, and dried at 80° C. for 3 hours under a load of about 1 kg, to prepare an MEA (2).

Preparation of MEA (3)

A carbon carrier impregnated with fine catalyst particles of platinum/ruthenium alloy (50/50 by atom) at 50% by weight was slurried with a mixed water/alcohol solvent (water, isopropanol and normal propanol, 20/40/40 by weight) containing an electrolytic binder composed of 30% by weight perfluorocarbon sulfonic acid (Nafion 117, trade name, DuPont). The slurry was spread on a polyimide film to form an about 30 μm thick catalyst layer by screen printing, to prepare a porous anode film. Next, a carbon carrier impregnated with fine catalyst particles of platinum at 30% by weight was slurried with a mixed water/alcohol solvent containing an electrolytic binder composed of 30% by weight perfluorocarbon sulfonic acid (Nafion 117, trade name, DuPont). The slurry was spread on a polyimide film to form an about 10 μm thick catalyst layer by screen printing, to prepare a porous cathode film. The porous anode and cathode films were cut into 10 mm wide, 20 mm long shapes, to prepare the anode and cathode. About 0.5 mL of a 5% by weight solution of Nafion 117 dissolved in a mixed solvent of water, isopropanol and normal propanol (20/40/40 by weight, Fluka Chemika) was penetrated into the anode surface. Then, the surface-treated anode was bonded to the power-generation section of the electrolyte membrane of sulfomethylated polyether sulfone prepared in (4) above, cut into a 16 mm wide, 33 mm long shape, and dried at 80° C. for 3 hours under a load of about 1 kg. Next, about 0.5 mL of a 5% by weight solution of Nafion 117 dissolved in a mixed solvent of water, isopropanol and normal propanol (20/40/40 by weight, Fluka Chemika) was penetrated into the cathode surface. Then, the surface-treated cathode was bonded to the electrolyte membrane in such a way to lap over the anode layer prepared above, and dried at 80° C. for 3 hours under a load of about 1 kg, to prepare an MEA (3).

(6) Preparation of Fuel Cell (DMFC) Power Systems

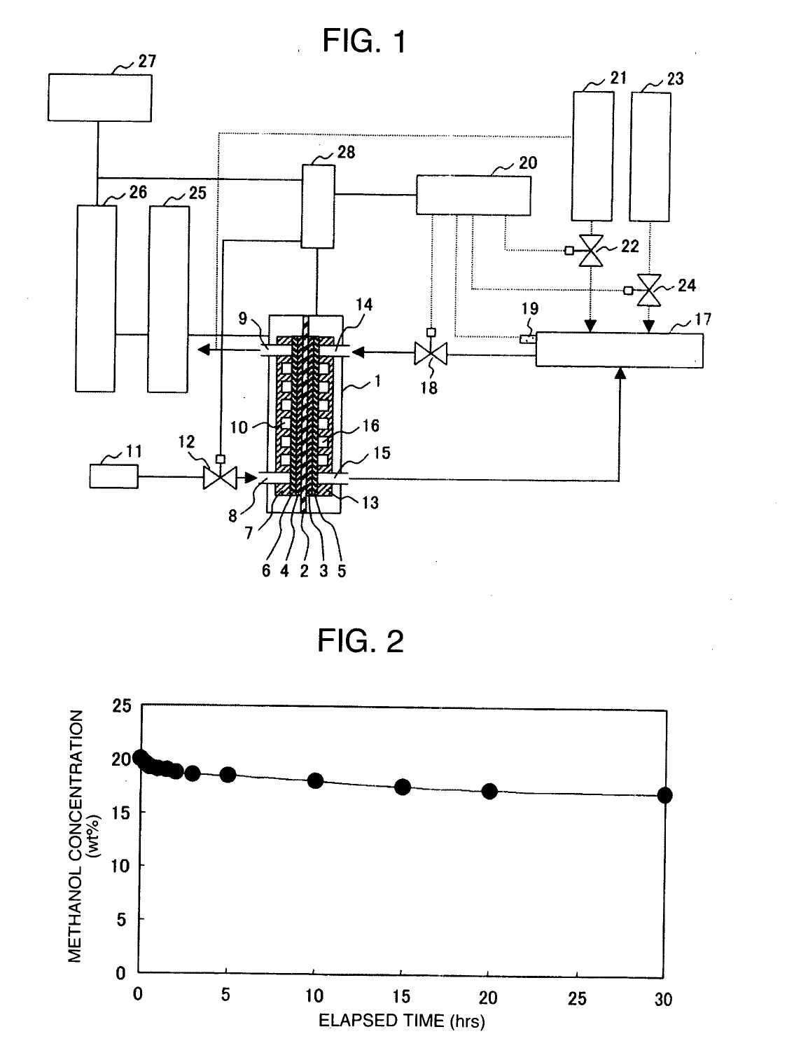

FIG. 1 structurally outlines a fuel cell power system. It comprises a membrane electrode assembly (MEA), which is a monolithic structure of the anode catalyst layer 4 and cathode catalyst layer 4 on each side of the polymer electrolyte membrane 2, with the anode current collector 5 and cathode current collector 6 closely bonded to the respective catalyst layers. The air passage plate 7 is set on the collector 6 side to form the air passage 10 comprising the air supply port 8 and air exhaust 9. The air supply port 8 is connected to the oxidant supply means 12 of air blower, air pump or the like responsible for sending air as the oxidant 11. On the other hand, the fuel passage plate 13 is set on the collector 5 side to form the fuel passage 16 comprising the fuel supply port 14 and fuel exhaust 15. The aqueous methanol solution tank 17 is connected to the fuel supply port 14 via the liquid sending pump 18. The aqueous methanol solution, supplied from the aqueous methanol solution tank 17 by the liquid sending pump 18, is sent from the fuel supply port 14 on the fuel passage plate 13 to the grooved portions (fuel passage 16) also on the fuel passage plate 13, on which it flows. The projected portions on the fuel passage plate 13 are in contact with the anode current collector 5 of anode carbon paper or the like, through which the aqueous methanol solution flowing in the fuel passage 16 soaks to be supplied into the anode catalyst layer 3. The electrons dissociated by the reaction between the methanol solution and water flow through the current corrector to the DC-DC converter 25, which increases voltage of the electrons, and then to the external circuit 27 via the lithium ion secondary battery or super capacitor 26. The lithium ion secondary battery or super capacitor 26 also drives the power source 28 for auxiliary devices, e.g., controller 20 and liquid-sending pumps 18, 22 and 24. Part of the electrons generated may directly drive the power source 28 for auxiliary devices, e.g., controller 20 and liquid-sending pumps 18, 22 and 24 after passing through the current collector in consideration of efficiency.

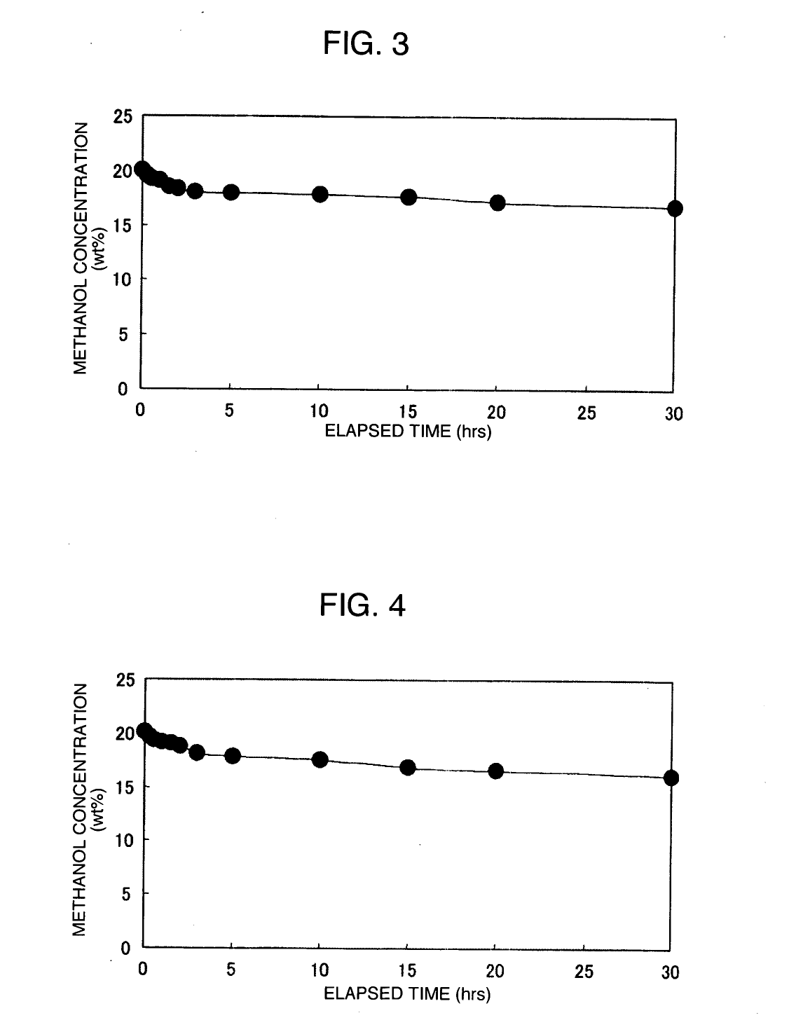

The DMFC power system, illustrated in FIG. 1, was prepared by incorporating each of the MEA (1), (2) or (3) prepared in (5) described above. The liquid sending pumps 22 and 24, directly connected to the water container 21 and methanol solution container 23, were stopped, and a 20% by weight aqueous methanol solution was first charged in the aqueous methanol solution container 17. It was circulated in the system by the liquid sending pump 18, to follow temporal changes of its concentration under a load of 100 mA/cm². Its temperature was kept at about 30° C. in each case. FIGS. 2, 3 and 4 present temporal changes of methanol concentration in the DMFC power systems each with the built-in MEA (1), (2) or (3), respectively. As shown, the methanol concentration was stabilized at around 17% by weight in each system. This means that a power system can produce a stable output without a mechanism of sensing and controlling liquid fuel concentration in a fuel cell, when an electrolyte membrane having a liquid fuel permeability of 12 mA/cm² is used and a make-up liquid fuel is kept at a concentration of 20% by weight or more, because the liquid fuel can have an essentially constant concentration after a lapse of certain time.

### COMPARATIVE EXAMPLE 1

(1) Preparation of Solution for Coating Electrode Catalyst and Electrolyte Electrode Assembly (MEA)

A carbon carrier impregnated with fine catalyst particles of platinum/ruthenium alloy (50/50 by atom) at 50% by weight was slurried with a mixed water/alcohol solvent (water, isopropanol and normal propanol, 20/40/40 by weight) containing an electrolytic binder composed of 30% by weight perfluorocarbon sulfonic acid (Nafion 117, trade name, DuPont). The slurry was spread on a polyimide film to form an about 30 μm thick catalyst layer by screen printing, to prepare a porous anode film. Next, a carbon carrier impregnated with fine catalyst particles of platinum at 30% by weight was slurried with a mixed water/alcohol solvent containing an electrolytic binder composed of 30% by weight perfluorocarbon sulfonic acid (Nafion 117, trade name, DuPont). The slurry was spread on a polyimide film to form an about 10 μm thick catalyst layer by screen printing, to prepare a porous cathode film. The porous anode and cathode films were cut into 10 mm wide, 20 mm long shapes, to prepare the anode and cathode. About 0.5 mL of a 5% by weight solution of Nafion 117 dissolved in a mixed solvent of water, isopropanol and normal propanol (20/40/40 by weight, Fluka Chemika) was penetrated into the anode surface. Then, the surface-treated anode was bonded to the power-generation section of the electrolyte membrane of Nafion 115 (thickness: 125 μm), cut into a 16 mm wide, 33 mm long shape, and dried at 80° C. for 3 hours under a load of about 1 kg. Next, about 0.5 mL of a 5% by weight solution of Nafion 115 dissolved in a mixed solvent of water, isopropanol and normal propanol (20/40/40 by weight, Fluka Chemika) was penetrated into the cathode surface. Then, the surface-treated cathode was bonded to the electrolyte membrane in such a way to lap over the anode layer prepared above, and dried at 80° C. for 3 hours under a load of about 1 kg, to prepare an MEA (4).

(2) Preparation of Fuel Cell (DMFC) Power System

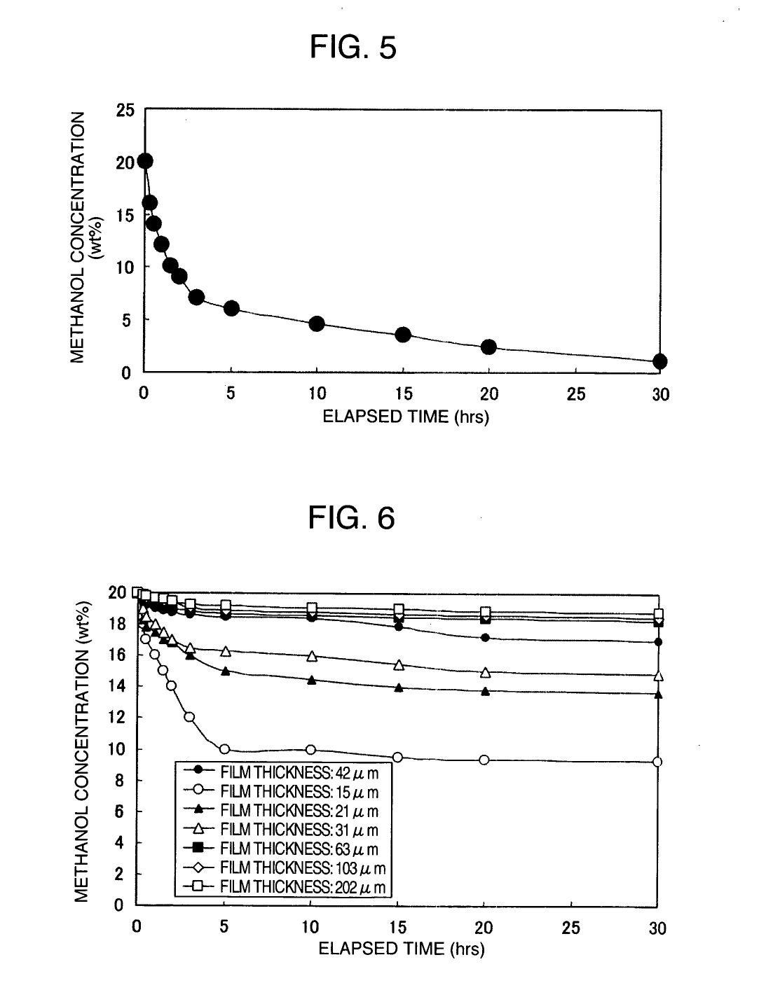

The DMFC power system, illustrated in FIG. 1, was prepared by incorporating the MEA (4) prepared above. The liquid sending pumps 22 and 24, directly connected to the water container 21 and methanol solution container 23, were stopped, and a 20% by weight aqueous methanol solution was first charged in the aqueous methanol solution container 17. It was circulated in the system by the liquid sending pump 18, to follow a temporal change of its concentration under a load of 100 mA/cm². Its temperature was kept at about 30° C. in each case. The methanol concentration continuously decreased with time, eventually to almost zero, as shown in FIG. 5, and the system could not generate power. Therefore, the DMFC power system with the built-in MEA in which the electrolyte membrane of perfluorosulfonic acid was incorporated could not stably produce output, unless the methanol concentration in the fuel cell was sensed and controlled. The electrolyte membrane of Nafion 115 had a methanol permeability of 100 mA/cm² and ion conductivity of 0.085 S/cm at room temperature.

As discussed above, a fuel cell power system can produce a stable output without a mechanism of sensing and controlling liquid fuel concentration in a fuel cell, when an electrolyte membrane having a liquid fuel permeability of 12 mA/cm² is used and a make-up liquid fuel is kept at a concentration of 20% by weight or more, because the liquid fuel can have an essentially constant concentration after a lapse of certain time, unlike a system which uses an electrolyte membrane having a liquid fuel permeability of 100 mA/cm² and runs on a methanol fuel having a concentration of 20% by weight.

### EXAMPLE 2

(1) Synthesis of Sulfopropylated Polyether Sulfone

A 500 mL four-mouthed, round-bottomed flask, equipped with a stirrer, thermometer, calcium chloride tube and reflux condenser, was charged with 21.6 g of polyether sulfone (PES), 12.2 g (0.1 mols) of propane sultone and 50 mL of dried nitrobenzene, after it was purged with nitrogen, to which a 14.7 g (0.11 mols) of anhydrous aluminum chloride was added with stirring in about 30 minutes. On completion of addition of anhydrous aluminum chloride, the mixture was treated under reflux for 8 hours. Then, the reaction solution was poured into 500 mL of ice water incorporated with 25 mL of concentrated sulfuric acid to terminate the reaction, to which 1 L of deionized water was added dropwise to separate out sulfopropylated polyether sulfone. It was recovered by filtration. The separated precipitate was washed with deionized water in a mixer and filtered under a vacuum for recovery repeatedly until the filtrate became neutral, and then dried at 120° C. for a night under a vacuum. The sulfopropylated polyether sulfone produced contained the ion-exchanged group at 1.1 meq/g.

(2) Preparation of Electrolyte Membrane

The product prepared in (1) above was dissolved in a mixed solvent of N,N′-dimethylformamide, cyclohexanone and methylethylketone (20/80/25 by volume) to a varying content. The solution was developed on glass by spin coating, dried in air and then dried at 80° C. under a vacuum, to form an electrolyte membrane of varying thickness (14, 21, 31, 42, 63, 103 or 202 μm). The characteristics of the electrolyte membranes are given in Table 1.

TABLE 1

| | a | b | c | d | e | f | g |
|---|---|---|---|---|---|---|---|
| Sulfone acid group content (meq/g) | 1.1 | | | | | | |
| Ion conductivity (S/cm) | 0.05 | | | | | | |
| Methanol permeability (mA/cm²) | 20 | 18 | 15 | 12 | 7 | 0.3 | 0.02 |
| Film thickness (μm) | 15 | 21 | 31 | 42 | 63 | 103 | 202 |
| MEA names | MEA<5> | MEA<6> | MEA<7> | MEA<8> | MEA<9> | MEA<10> | MEA<11> |

(3) Preparation of Membrane Electrode Assemblies (MEAs)

A carbon carrier impregnated with fine catalyst particles of platinum/ruthenium alloy (50/50 by atom) at 50% by weight was slurried with a 30% by weight solution of the sulfopropylated polyether sulfone prepared in (1) above dissolved in a mixed solvent of 1-propanol, 2-propanol and methoxy ethanol. The slurry was spread on a polyimide film to form an about 30 μm thick catalyst layer by screen printing, to prepare a porous anode film. Next, a carbon carrier impregnated with fine catalyst particles of platinum at 30% by weight was slurried with a mixed water/alcohol solvent containing a binder composed of the sulfopropylated polyether sulfone prepared in (1) above dissolved in a mixed solvent of 1-propanol, 2-propanol and methoxy ethanol. The slurry was spread on a polyimide film to form an about 10 μm thick catalyst layer by screen printing, to prepare a porous cathode film. The porous anode and cathode films were cut into 10 mm wide, 20 mm long shapes, to prepare the anode and cathode. About 0.5 mL of a 5% by weight solution of the sulfopropylated polyether sulfone prepared in (1) above dissolved in a mixed solvent of 1-propanol, 2-propanol and methoxy ethanol was penetrated into the anode surface. Then, the surface-treated anode was bonded to the power-generation section of the electrolyte membrane of sulfopropylated polyether sulfone prepared in (2) above, cut into a 16 mm wide, 33 mm long shape, and dried at 80° C. for 3 hours under a load of about 1 kg. Next, about 0.5 mL of a 5% by weight solution of the sulfopropylated polyether sulfone prepared in (1) above dissolved in a mixed solvent of 1-propanol, 2-propanol and methoxy ethanol was penetrated into the cathode surface. Then, the surface-treated cathode was bonded to the electrolyte membrane in such a way to lap over the anode layer prepared above, and dried at 80° C. for 3 hours under a load of about 1 kg, to prepare an MEA. In this manner, a total of 12 MEAs (MEA (5) to (11) of varying electrolyte membrane thickness were prepared.

(4) Preparation of Fuel Cell (DMFC) Power Systems

The DMFC power system, illustrated in FIG. 1, was prepared by incorporating each of the MEAs (5) to (11) prepared in (3) described above. The liquid sending pumps 22 and 24, directly connected to the water container 21 and methanol solution container 23, were stopped, and a 20% by weight aqueous methanol solution was first charged in the aqueous methanol solution container 17. It was circulated in the system by the liquid sending pump 18, to follow temporal changes of its concentration under a load of 100 mA/cm². Its temperature was kept at about 30° C. in each case. FIG. 6 presents temporal changes of methanol concentration in the DMFC power systems. As shown, the methanol concentration was stabilized at around 17% by weight in each system. This means that a power system can produce a stable output without a mechanism of sensing and controlling liquid fuel concentration in a fuel cell, when an electrolyte membrane having a liquid fuel permeability of 0.02 to 20 mA/cm² is used and a make-up liquid fuel is kept at a concentration of 20% by weight or more, because the liquid fuel can have an essentially constant concentration after a lapse of certain time.

### EXAMPLE 3

(1) Preparation of Electrolyte Membrane of Sulfomethylated Polyether Sulfone

A total of 5 types of chloromethylated polyether sulfone of different chlotromethyl group introduced were prepared in the same manner as in EXAMPLE 1 (1) for synthesis of chloromethylated polyether sulfone, except that a composition of polyether sulfone, chloromethyl ether and anhydrous tin chloride. The same procedures as EXAMPLE 1 (2) for synthesis of acetylthio(polyether sulfone) and (3) for synthesis of sulfomethylated polyether sulfone were adopted to substitute the chloromethyl group in the chloromethylated polyether sulfone by acetylthio group and then to synthesize sulfomethylated polyether sulfone. The same film-making procedure as EXAMPLE 1 (4) preparation of electrolyte membrane was adopted to prepare an about 40 μm thick electrolyte membrane of each sulfomethylated polyether sulfone type. The characteristics of the electrolyte membranes are given in Table 2.

TABLE 2

| | Example 3 | | | | | | |
|---|---|---|---|---|---|---|---|
| Sulfone acid group content (meq/g) | 0.8 | 0.95 | 1.1 | 1.2 | 1.3 | 1.4 | 1.6 |
| Ion conductivity (S/cm) | 0.005 | 0.01 | 0.05 | 0.07 | 0.09 | 0.11 | 0.18 |
| Methanol permeability (mA/cm²) | 0.02 | 2 | 12 | 24 | 36 | 50 | 70 |
| Film thickness (μm) | 42 | | | | | | |
| MEA names | MEA<12> | MEA<13> | MEA<14> | MEA<15> | MEA<16> | MEA<17> | MEA<18> |
| Reference drawing numbers | | | | | | | |

(2) Preparation of Membrane Electrode Assemblies (MEAs)

A carbon carrier impregnated with platinum/ruthenium at 40% by weight was uniformly dispersed in a solution of the sulfomethylated polyether sulfone prepared in EXAMPLE 1 (3) dissolved in a mixed solvent of 1-propanol, 2-propanol and methoxy ethanol to have a platinum/ruthenium catalyst/high-molecular-weight electrolyte ratio of 2/1 by weight. The resulting paste was used as a solution for coating the electrode catalyst. It was spread on one side of the electrolyte membrane prepared in EXAMPLE 1 (1) and dried to prepare an anode impregnated with platinum/ruthenium at 6 mg/cm². Next, a carbon carrier impregnated with platinum at 40% by weight was uniformly dispersed in a solution of the sulfomethylated polyether sulfone prepared in EXAMPLE 1 (3) dissolved in a mixed solvent of 1-propanol, 2-propanol and methoxy ethanol to have a platinum catalyst/high-molecular-weight electrolyte ratio of 2/1 by weight. The resulting paste was used as a solution for coating the electrode catalyst. It was spread on the other side of the electrolyte membrane and dried to prepare a cathode impregnated with platinum at 2 mg/cm². These anode and cathode were used to prepare the MEAs (12) to (18).

(3) Preparation of Fuel Cell (DMFC) Power Systems

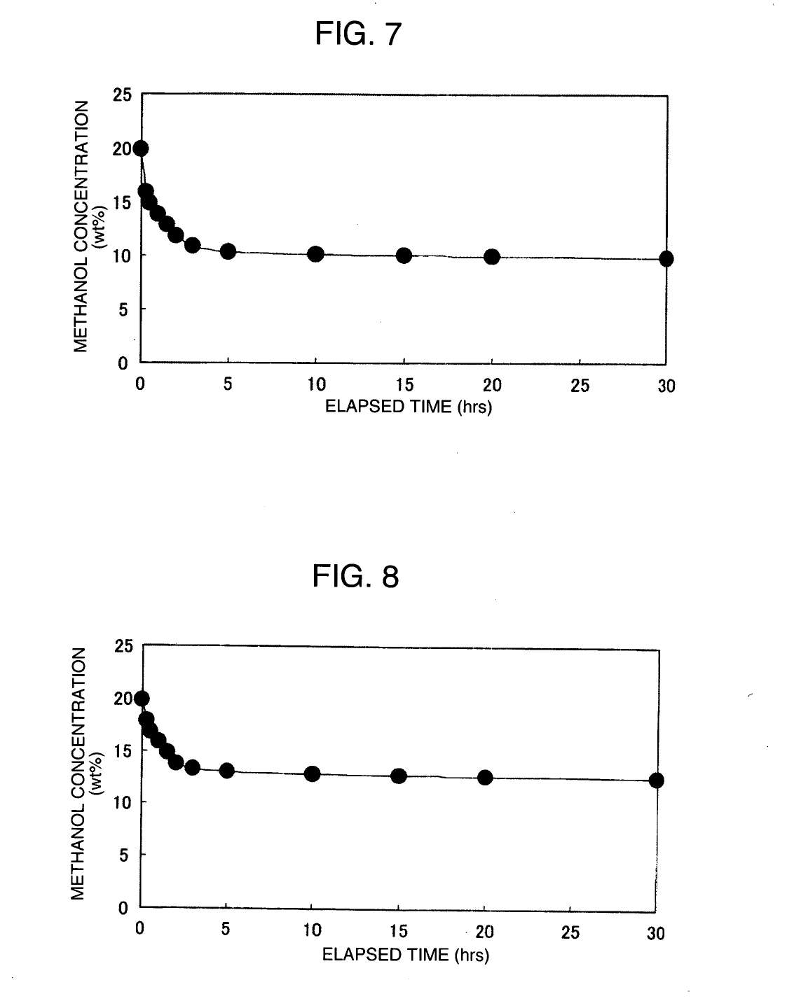

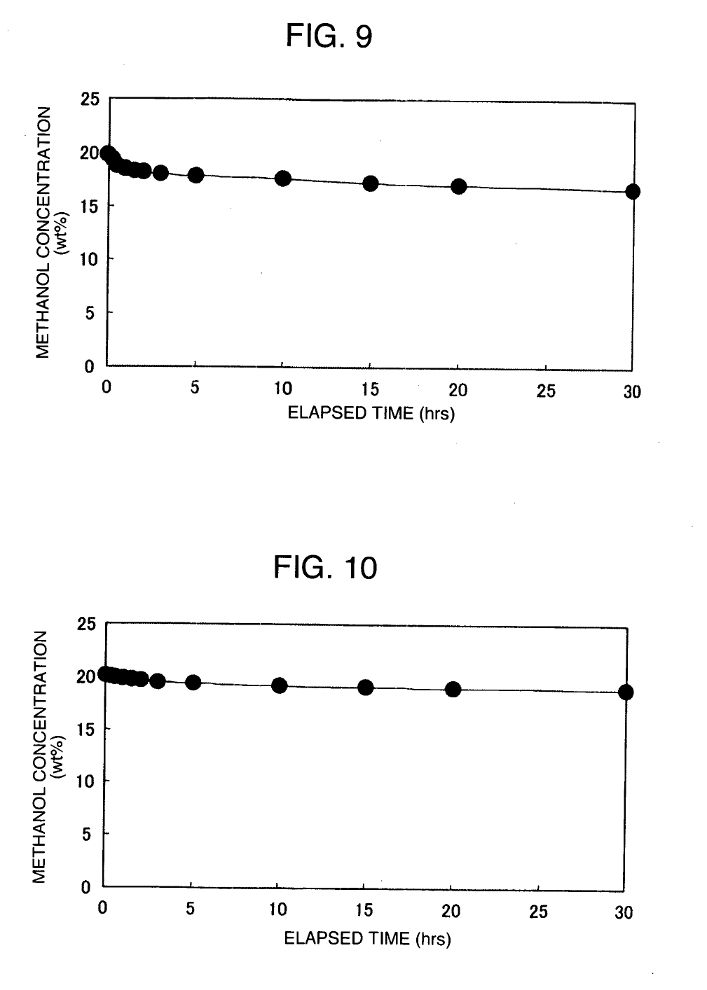

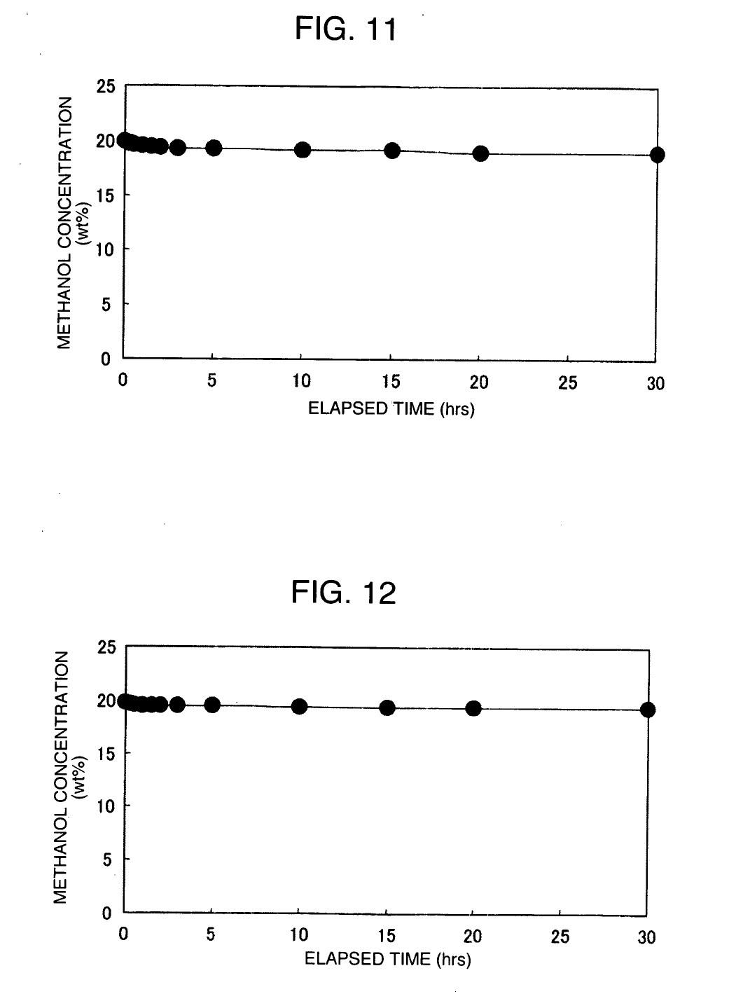

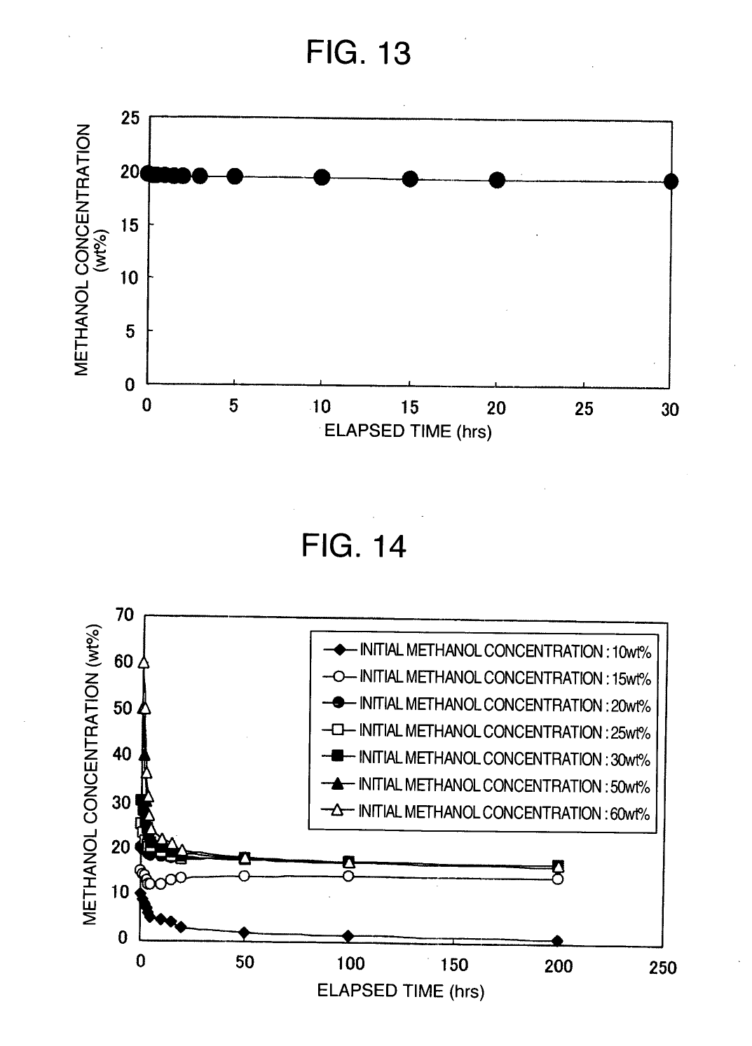

The DMFC power system, illustrated in FIG. 1, was prepared by incorporating each of the MEAs (12) to (18) prepared in (2) described above. The liquid sending pumps 22 and 24, directly connected to the water container 21 and methanol solution container 23, were stopped, and a 20% by weight aqueous methanol solution was first charged in the aqueous methanol solution container 17. It was circulated in the system by the liquid sending pump 18, to follow temporal changes of its concentration under a load of 100 mA/cm². FIGS. 7 to 13 present temporal changes of methanol concentration in the DMFC power systems each with one of the built-in MEAs (12) to (18), respectively. As shown, the methanol concentration was stabilized at around 17% by weight in each system. This means that a power system can produce a stable output without a mechanism of sensing and controlling liquid fuel concentration in a fuel cell, when an electrolyte membrane having a liquid fuel permeability of 0.02 to 70 mA/cm² is used and a make-up liquid fuel is kept at a concentration of 15% by weight or more, because the liquid fuel can have an essentially constant concentration after a lapse of certain time.

### EXAMPLE 4

The DMFC power system, illustrated in FIG. 1, was prepared by incorporating the MEA (14) prepared in EXAMPLE 3. The liquid sending pumps 22 and 24, directly connected to the water container 21 and methanol solution container 23, were stopped, and an aqueous methanol solution of varying methanol concentration (10, 15, 20, 25, 30, 50 or 60% by weight) was first charged in the aqueous methanol solution container 17. It was circulated in the system by the liquid sending pump 18, to follow temporal changes of its concentration under a load of 100 mA/cm². FIG. 14 presents temporal changes of methanol concentration in the DMFC power systems. As shown, a power system can produce a stable output without a mechanism of sensing and controlling liquid fuel concentration in a fuel cell, when an electrolyte membrane having a liquid fuel permeability of 12 mA/cm² is used and a make-up liquid fuel is kept at a concentration of 15% by weight or more, because the liquid fuel can have an essentially constant concentration after a lapse of certain time.

### EXAMPLE 5

(1) Preparation of Fuel Cell Power System

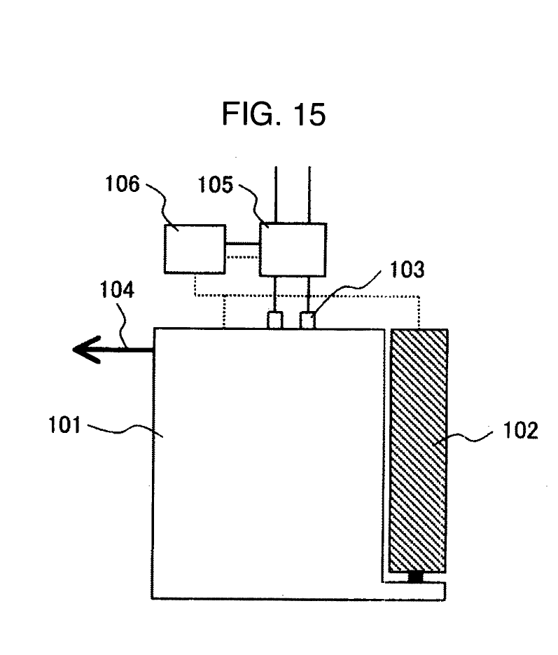

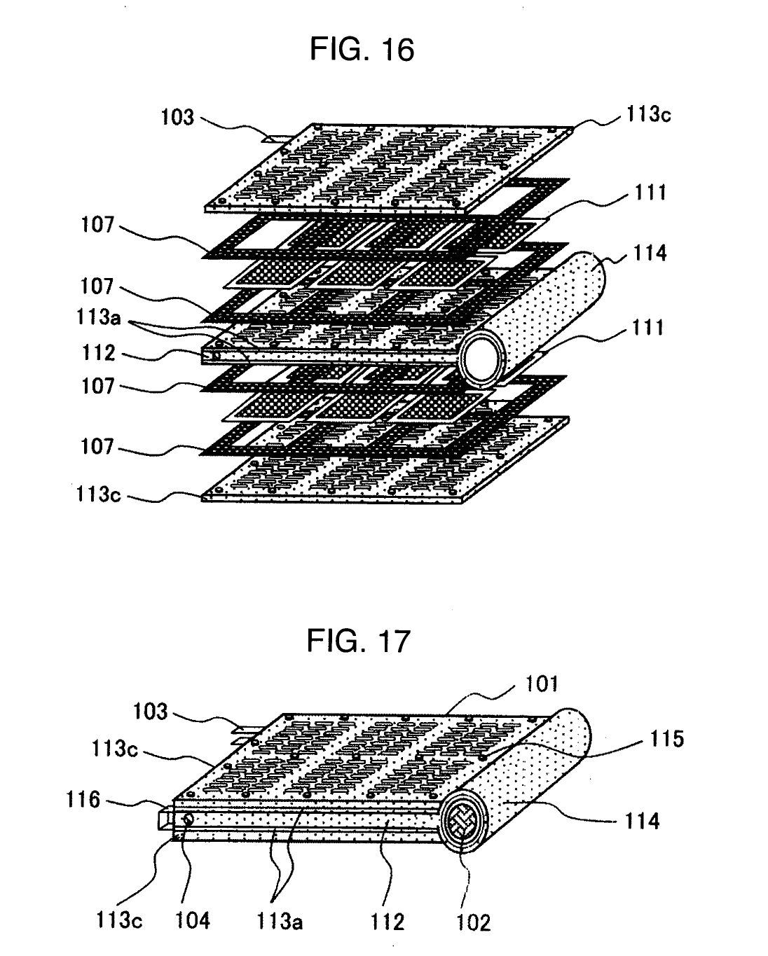

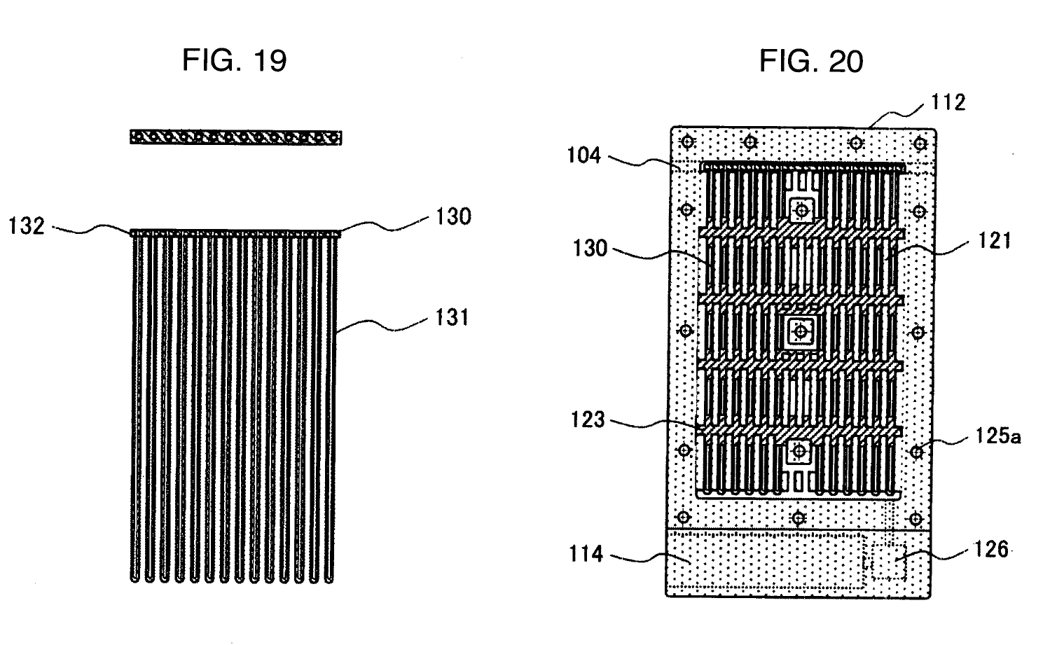

FIG. 15 illustrates the fuel cell structure of EXAMPLE 5. The system comprises the fuel cell 101, fuel cartridge tank 102, output terminal 103 and gas exhaust 104. The gas exhaust 104 is provided to discharge carbon dioxide gas, produced on the anode side, from the fuel chamber 112 (FIG. 16). The fuel cartridge tank 102 sends a fuel by the aid of high-pressure liquefied gas, high-pressure gas, spring or the like, supplying the fuel to the fuel chamber 112, illustrated in FIG. 16 and, at the same time, keeping pressure within the fuel chamber 112 at higher than atmospheric with the liquid fuel. It makes up, under pressure, for the fuel consumed in the fuel chamber 112 for generating power, and supplies power which it generates to a loading apparatus via the DC/DC converter 105. It is provided with the controller 106 designed to control the DC/DC converter 105 on receiving a signal related to fuel remaining in the fuel cell 101 and fuel cartridge tank 102, operation or stoppage of the DC/DC converter 105 and the like, and issue a warning, as required. The controller 106 can be designed, as required, to display various power source operating conditions, e.g., fuel cell voltage, output current and cell temperature, on a loading apparatus. Moreover, it can stop power supply from the DC/DC converter 105 to a loading apparatus in an emergency condition, e.g., when fuel level in the fuel cartridge tank 102 goes below a given level, or air diffusion rate is out of a given range, and, at the same time, issue an emergency warning by sound, pilot light, letters or the like. It can also display a remaining fuel level on a loading apparatus in a normal operating condition, on receiving the related signal from the fuel cartridge tank 102. FIG. 16 illustrates one embodiment of fuel cell member structure for the present invention. The fuel cell 101 has a structure with the anode terminal plate 113a, gasket 107, MEA 111 equipped with a diffusion layer, gasket 107 and cathode terminal plate 113c stacked on each side of the fuel chamber 112 equipped with the cartridge holder 114. These members are assembled and fixed for the fuel cell 101 by the screws 115 (FIG. 17) in such a way to keep pressure at an almost uniform level on each plane in the stacked structure. The MEA 111 in example 5 was the MEA (1) prepared in EXAMPLE 1. FIG. 17 shows an external appearance of the fuel cell which has a power-generation section comprising six MEAs 111 each equipped with a diffusion layer, arranged on a plane on each side of the fuel chamber assembled and fixed. The fuel cell 101 has a structure with a plurality of single cells connected to each other in series by the connecting terminals 116 on each side of the fuel chamber 102, to output power from the output terminal 103. In FIG. 17, a fuel is supplied under pressure from the fuel cartridge tank 102 by the aid of high-pressure liquefied gas, high-pressure gas, spring or the like, and carbon dioxide gas (not shown in this figure) produced on the anode is discharged from the gas exhaust 104 via the gas exhaust module 130, one embodiment of which is illustrated in FIG. 19. The gas exhaust module 130 has functions of gas/liquid separation and collecting exhaust gas. On the other hand, air as an oxidant is supplied after diffusing through the air diffusion slits 122c, and water produced on the cathode is discharged through the slits 122c. The clamping method for assembling the cell is not limited to the one disclosed in EXAMPLE 5, which is aided by screws. It may be assembled by other methods, e.g., by a compressive force from a box in which it is encased.

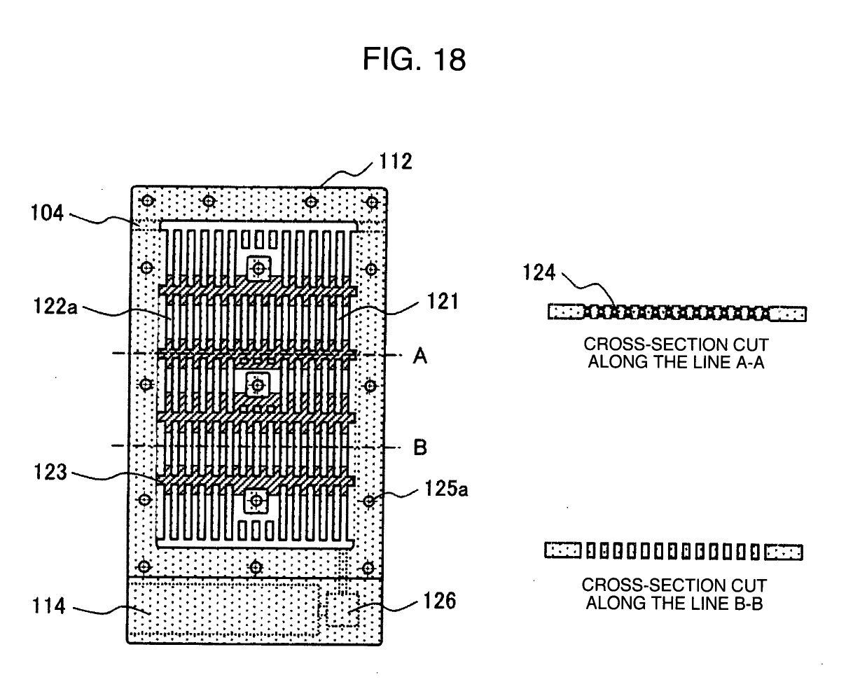

FIG. 18 illustrates one embodiment of the fuel chamber 112 structure of the fuel cell power system of the present invention. The fuel chamber 112 is provided with a plurality of ribs 121 which distribute a fuel. These ribs 121 are supported by the rib supporting plates 123 to form the slits 122a which penetrate the chamber 112. The rib supporting plate 123 is sufficiently thinner than the fuel chamber 112, and is also provided with a groove for fuel distribution. It is also provided with the supporting hole 124 which supports the gas/liquid separation tube 131, disclosed in FIG. 19. Moreover, the fuel chamber 112 is equipped with the gas exhaust 104, holes 125a for cell clamping screws, fuel cartridge receiving port 126 and fuel cartridge holder 114. Any material can be used for the fuel chamber 112, so long as it can have a flat/smooth plane to which a pressure is applied uniformly when the MEAs are attached, and also can be formed into an insulated structure to prevent a short circuit between the cells set on the plane. It is recommended to select the material from high-density polyethylene, high-density polypropylene, epoxy resin, polyetheretherketone, polyether sulfone and polycarbonate, which may be reinforced with glass fibers. Other materials useful for the fuel chamber 112 include carbon, steel, nickel, light-weight alloys (e.g., of aluminum or magnesium) intermetallic compounds (represented by copper-aluminum or the like) and various types of stainless steel, which are surface-treated or coated with a resin to be insulating.

The slits 122a for distributing fluids, e.g., fuel and oxidant gas, have apertures running in parallel to each other in the structure illustrated in FIG. 17. However, the structure is not limited to the above, so long as it can uniformly distribute fluids over the plane. Moreover, the cell constituent members are uniformly clamped by screws to secure the electrical contacts and seal a liquid fuel. However, the structure is also not limited to the one disclosed in EXAMPLE 5. For example, it is an effective procedure to bond the cell members by an adhesive, high-molecular-weight film and press/clamp them by a case in which the cell is contained, in order to reduce weight and thickness of the power source.

FIG. 20 illustrates an external appearance of one embodiment of the present invention in which the fuel chamber 112 of the structure shown in FIG. 18 is combined with the gas exhaust module 130 of the structure shown in FIG. 19. Each of the gas/liquid separation tubes 131 in the gas exhaust module 130 is set through the supporting hole 124 in the rib supporting plate 123 for the fuel chamber 112. The module base board 132, connected to the gas exhaust 104, functions to discharge the gas recovered by the gas/liquid separation tube 131 to the cell outside. This structure allows the gas/liquid separation tube 131 to be placed near and at essentially equal distances from the two anodes facing each other, on which carbon dioxide gas is produced. As a result, the fuel chamber is filled with a liquid fuel at a given pressure, when the fuel cartridge is set. When it is out of service, water repellency of the gas/liquid separation tube prevents a liquid fuel from entering the pores in the tube until it attains a given pressure, with the result that no fuel leakage occurs at below a given pressure. Gases dissolved in the fuel and carbon dioxide gas produced are captured by the gas/liquid separation tube 131 to be discharged to the cell out side at a liquid fuel pressure. Therefore, film thickness, average pore diameter, pore diameter distribution and aperture ratio of the gas/liquid separation tube are determined in accordance with initial and final pressure at the fuel cartridge, and rate of carbon dioxide gas produced at the maximum cell output.

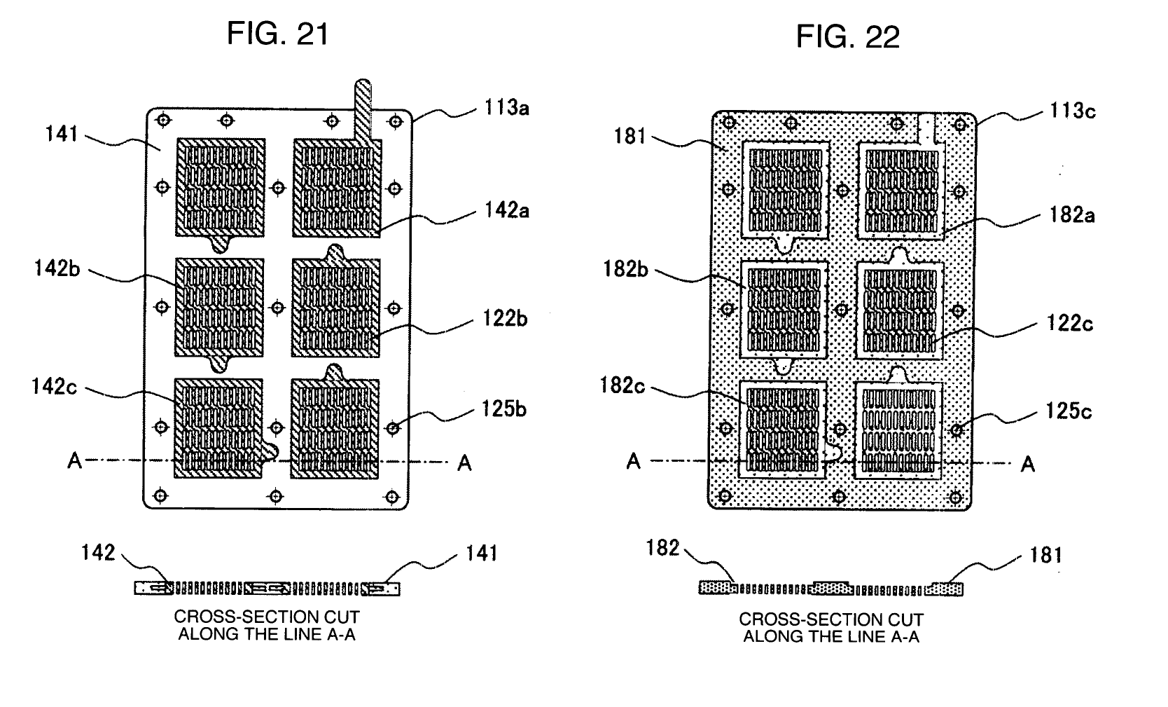

FIG. 21 illustrates one embodiment of anode terminal plate 113a structure to be joined to the fuel chamber. The anode terminal plate 113a supports 6 single cells on the same plane, 3 current collectors 142a, 142b and 142c of different electron conductivity and corrosion resistance for connecting the cells in series, and insulation sheet 141, which are joined to each other to form an assembly structure, where each current collector is provided with a plurality of slits 122b. The insulation sheet 141 is provided with a plurality of screw holes 125b for clamping the cell members into an assembly structure. Moreover, any material may be used for the sheet 141, which constitutes the anode terminal plate 113a, so long as it allows the current collectors 142 placed on the same plane to be joined to each other to form an assembly structure, and secures insulation capacity and flatness of the plane. It is recommended to select the material from high-density vinyl chloride, high-density polyethylene, high-density polypropylene, epoxy resin, polyetheretherketone, polyether sulfone, polycarbonate and polyimide-based resin, which may be reinforced with glass fibers. Other useful materials include carbon, steel, nickel, light-weight alloys (e.g., of aluminum or magnesium) intermetallic compounds (represented by copper-aluminum or the like) and various types of stainless steel, which can be connected to the current collector 142 after being surface-treated or coated with a resin to be insulating.

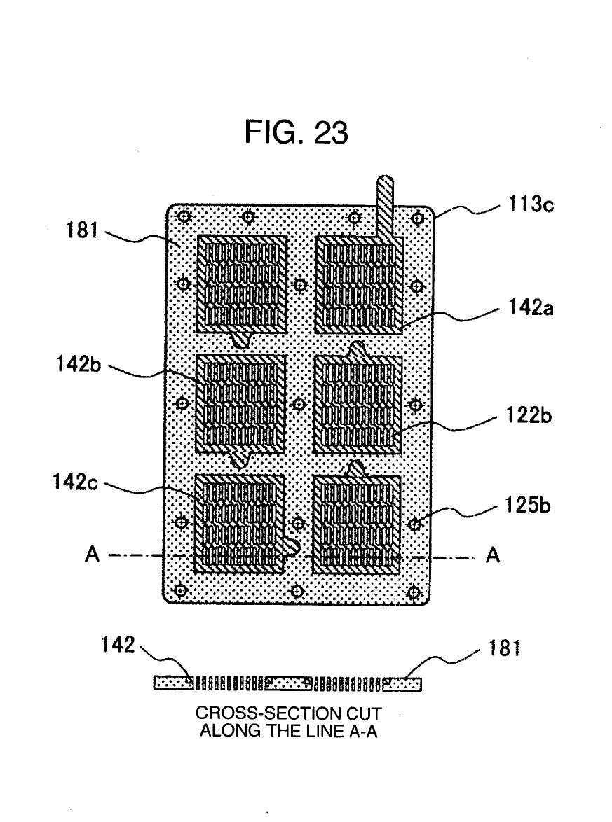

FIG. 22 illustrates one embodiment of cathode terminal plate 113c structure which supports a plurality of single cells connected in series to each other on the same plane. It is provided with the spot-faced sections 182a, 182b and 182c at which a plurality of the current collectors 142 are joined to the base board 181, slits 122c through which air as an oxidant and steam as the reaction product diffuse towards the spot-faced sections 182, and a plurality of screw holes 125b for clamping the cell members into an assembly structure. Any material may be used for the base board 181, so long as it allows the current collectors 142 placed on the same plane to be joined to each other, secures insulation capacity and flatness of the plane, and is sufficiently rigid to be clamped to the MEA on the same plane to secure a sufficiently low contact resistance between them. It is recommended to select the material from high-density vinyl chloride, high-density polyethylene, high-density polypropylene, epoxy resin, polyetheretherketone, polyether sulfone, polycarbonate and polyimide-based resin, which may be reinforced with glass fibers. Other useful materials include steel, nickel, light-weight alloys (e.g., of aluminum or magnesium) intermetallic compounds (represented by copper-aluminum or the like) and various types of stainless steel, which can be connected to the current collector 142 after being surface-treated or coated with a resin to be insulating.

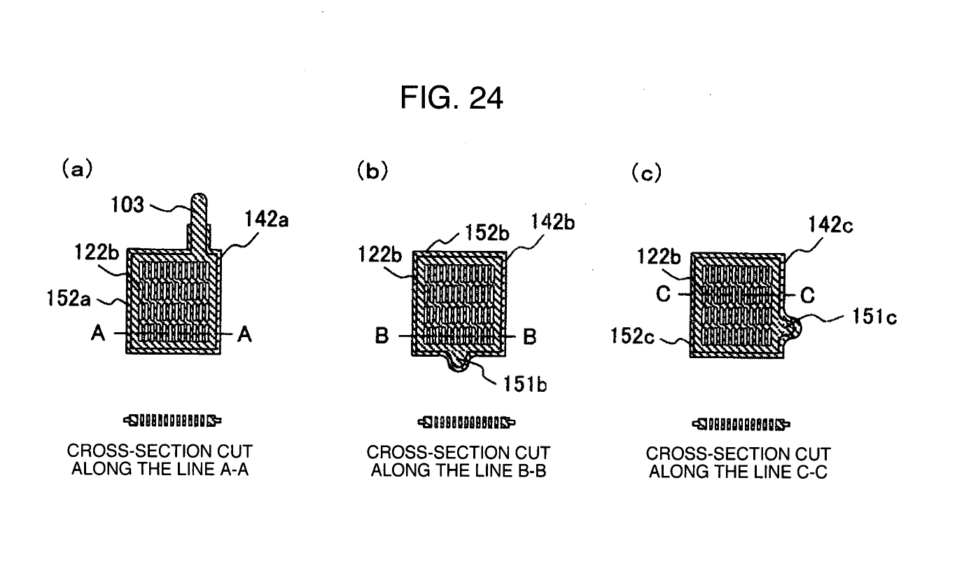

FIG. 23 outlines one embodiment of the cathode terminal plate 113, provided at the spot-faced section 182 on the base board 181, to which the current collector illustrated in FIG. 24 is bonded. The plate 113 is provided with the screw holes 125c for clamping the six current collectors, in contact with the respective single cell cathodes to collect current, to the fuel cell members to form an assembly structure.

The current collectors 142 are preferably fit into, and joined by an adhesive agent to, the respective spot-face sections in such a way that they are arranged to form the same plane as far as possible. The adhesive agent is not limited, so long as it is not dissolved in or swollen by an aqueous methanol solution, and electrochemically more stable than methanol. An epoxy resin agent is one of the preferable examples. The current collector 142 is not necessarily fixed by an adhesive agent. For example, it may be fixed by providing projections on the base board 181 and fitting them into part of the slits 122b on each of the current collectors 42 or specially provided holes. Moreover, it is not essential that each side of the current collectors 142 and base board 181 form the same plane. In the case of the plane of a stepped structure, for example, it is possible to join the current collectors 142 without the spot-faced sections 182 on the base board 181 by altering structure and thickness of the sealing gasket.

FIG. 24 illustrates one embodiment of current collector structure to be joined to the anode terminal plate 113a and cathode terminal plate 113c illustrated in FIGS. 21 and 23. Three types of current collectors, 142a, 142b and 142c, are used to connect the single cells in series on the same plane. The current collector 142a is provided with the cell output terminal 103 and also with the slits 122b, through which a fuel or air as an oxidant diffuses, on the plane. The current collectors 142b and 142c are provided with the respective interconnectors 151b and 151c to connect the single cells in series on the same plane, and also with the slits 122b. When these current collectors 142 are arranged on the anode terminal plate 113a, the fin 152 is provided to join them to the insulation sheet 141 shown in FIG. 21. When they are arranged on the cathode terminal plate 113c, on the other hand, a structure having no fin is adopted.

Materials for the current collector are not limited. They include carbon, metals (e.g., stainless steel, titanium and tantalum), composites including these metals (e.g., carbon steel, stainless steel, copper and nickel clads). When a metallic current collector is used, plating the fabricated current-carrying member with a corrosion-resistant noble metal (e.g., gold) or coating the member with an electroconductive carbon paint or the like to reduce contact resistance in the assembly is effective to increase cell output density and secure functional stability for extended periods.

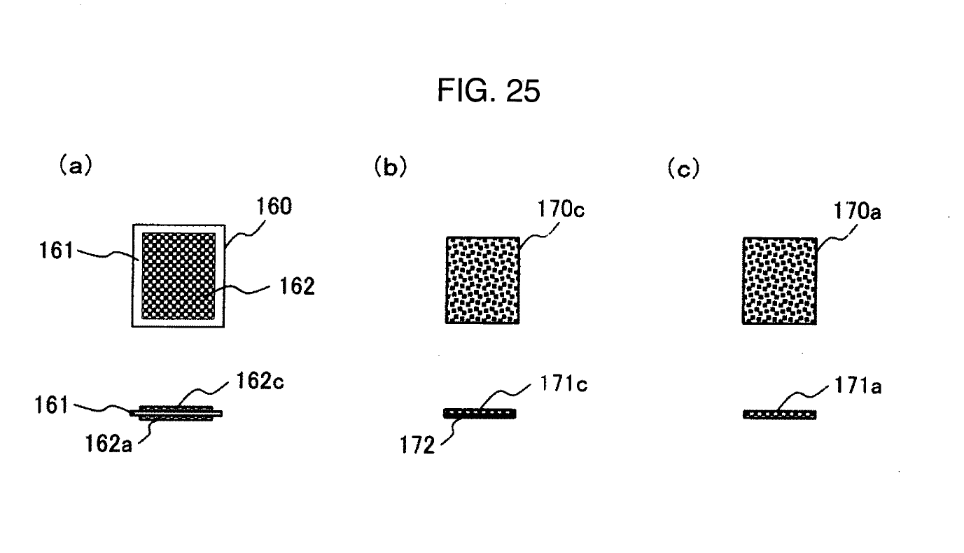

FIG. 25 (a) illustrates one embodiment of the MEA 160 structure for the present invention. The electrolyte membrane 161 is made of alkyl-sulfonated polyether sulfone. For the anode 162a, a catalyst comprising a carbon carrier (XC72R, Cabot) impregnated with platinum and ruthenium is used. For the cathode 162c, a catalyst comprising a carbon carrier (XC72R, Cabot) impregnated with platinum is used. The electrolyte membrane is bonded to the electrode by a binder of high-molecular-weight compound similar to the polyether sulfone for the electrolyte membrane, but sulfonated to a lesser extent. Use of such a binder increases water and methanol cross-over in the electrolyte dispersed in the electrode catalyst beyond those in the electrolyte membrane, thereby promoting fuel diffusion onto the electrode catalyst and hence improving electrode performance.

FIGS. 25 (b) and (c) illustrate the cathode diffusion layer 170c and anode diffusion layer 170a structures for the present invention, respectively. The cathode diffusion layer 170c comprises the water-repellent layer 172 and porous carbon base board 171c, the former increasing water repellency of the layer to increase steam pressure around the cathode, thereby promoting diffusion/discharge of steam produced and also preventing condensation of steam. The water-repellent layer 172 is stacked in such a way to come into contact with the electrode 162c. Plane contact between the anode diffusion layer and anode is not limited. In EXAMPLE 5, the porous carbon base board 171a was used for the plane contact. The porous carbon base board 171c for the cathode diffusion layer 170c is made of an electroconductive, porous material. It is generally in the form of woven or non-woven fabric of carbon fibers.

The cathode diffusion layer 170c is described in detail. Carbon paper (TGP-H-060, Toray) is cut into a shape of given dimensions. The carbon paper of predetermined water absorption rate is dipped in a polytetrafluorocarbon/water dispersion (D-1, Daikin Industries) diluted in such a way to keep the carbon paper content at 20 to 60% by weight after baking, and dried at 120° C. for 1 hour. It is then baked in air at 270 to 360° C. for 0.5 to 1 hour. The powdered carbon (XC72R, Cabot) is kneaded with the polytetrafluorocarbon/water dispersion to have a content of 20 to 60% by weight. The resulting pasty mixture is spread on one side of the carbon paper, treated to be water-repellent as described above, to a thickness of 10 to 30 μm. It is then dried at 120° C. for about 1 hour, and fired in air at 270 to 360° C. for 0.5 to 1 hour to prepare the cathode diffusion layer 170c. Air and moisture permeability, i.e., supplied oxygen and produced water diffusion capacities, of the cathode diffusion layer 170c greatly depend on addition rate and dispersibility of polytetrafluoroethylene and baking temperature. Therefore, the adequate conditions are selected in consideration of design performance and service environments of the fuel cell.

The anode diffusion layer 170a can be made of a woven or non-woven fabric of carbon fibers which can satisfy the conditions related to electroconductivity and porosity. The suitable woven fabrics of carbon fibers include carbon cloth (TORAYCA cloth, Toray) and carbon paper (TGP-H-060, Toray). The anode diffusion layer 170a works to accelerate supply of an aqueous solution fuel and discharge of carbon dioxide produced. Therefore, the porous carbon base board 171a is preferably treated to have the hydrophilic surface by mild oxidation or UV irradiation, or treated with a hydrophilic resin or strongly hydrophilic material (represented by titanium oxide)dispersed in the porous carbon base board 171a. These methods bring effects of preventing growth of bubbles of carbon dioxide gas, produced on the anode, within the porous carbon base board 171a and thereby enhancing fuel cell output density. Materials for the anode diffusion layer 170a are not limited to those described above. The other suitable materials include substantially electrochemically inactive metals, e.g., non-woven fabric of stainless steel fibers, and a porous material such as porous titanium and tantalum.

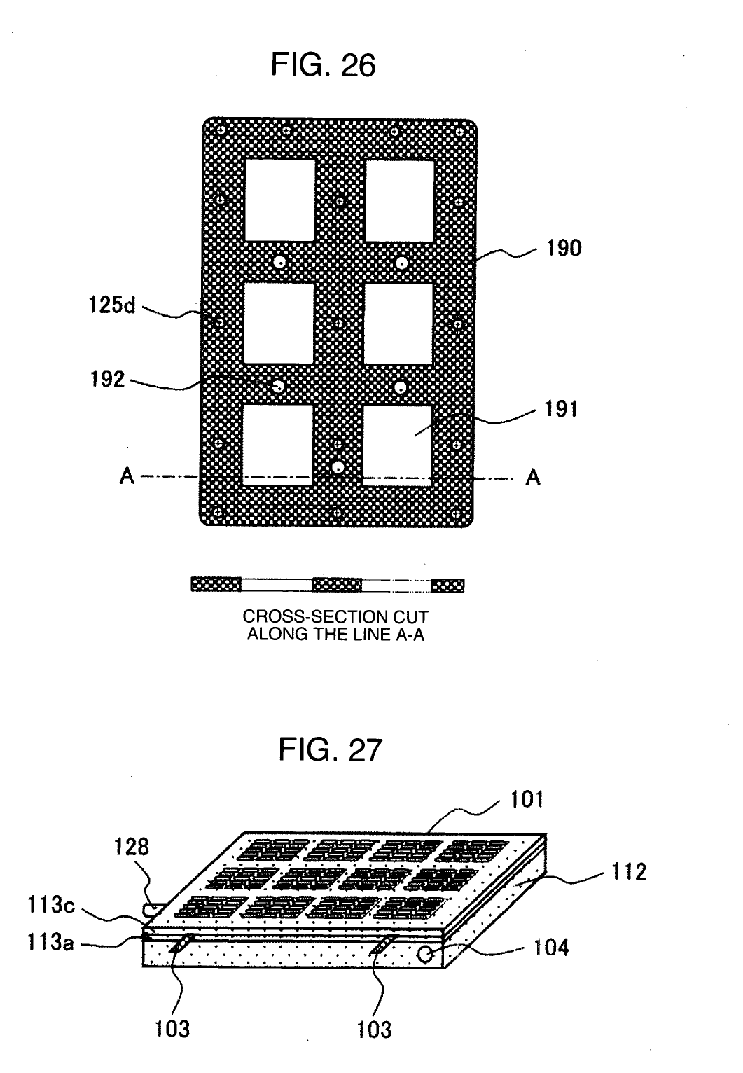

FIG. 26 illustrates one embodiment of gasket structure for the fuel cell power system of the present invention. The gasket 190 comprises the punched-out current-carrying sections 191 corresponding to a plurality of MEAs mounted, a plurality of screw holes for clamping screws, and connecting holes through which electroconductors run to connects interconnectors for the anode terminal plate 113a and cathode terminal plate 113c. The gasket 190 works to seal a fuel and oxidant gas to be supplied to the anode 162a and cathode 162c, respectively. It may be made of a commonly used material, e.g., synthetic rubber (e.g., EPDM, fluorine-based rubber or silicon rubber).

The above-described catalyst materials are described more specifically by citing EXAMPLES and COMPARATIVE EXAMPLE. In this example, a platinum/ruthenium alloy is described as the catalyst metal. The catalyst, however, is not limited to the above. For example, a platinum-containing catalyst metal can be used for a DMFC cathode.

Here, one embodiment of DMFC for a portable information terminal. FIG. 27 shows an external appearance of one embodiment of DMFC for a portable information terminal, for which the fuel cell power system of the present invention is used. The fuel cell 101 comprises the fuel chamber 112, an MEA with electrolyte membrane of sulfomethylated polyether sulfone (not shown), and cathode terminal plate 113c and anode terminal plate 113a with a gasket in-between, where a power-generation section is mounted only on one side of the fuel chamber 112. The fuel chamber 112 is provided with the fuel supply tube 128 and gas exhaust 104 on the circumference. Moreover, a pair of output terminals 103 are provided on the circumference of the anode terminal plate 113a and cathode terminal plate 113c. The assembled cell structure has the same member structure as that shown in FIG. 16, except that a power-generation section is mounted only on one side of the fuel chamber and a fuel cartridge holder is not integrated. The fuel chamber, anode terminal plate and cathode terminal plate are made of high-pressure vinyl chloride, polyimide resin and epoxy resin reinforced with glass fibers, respectively.

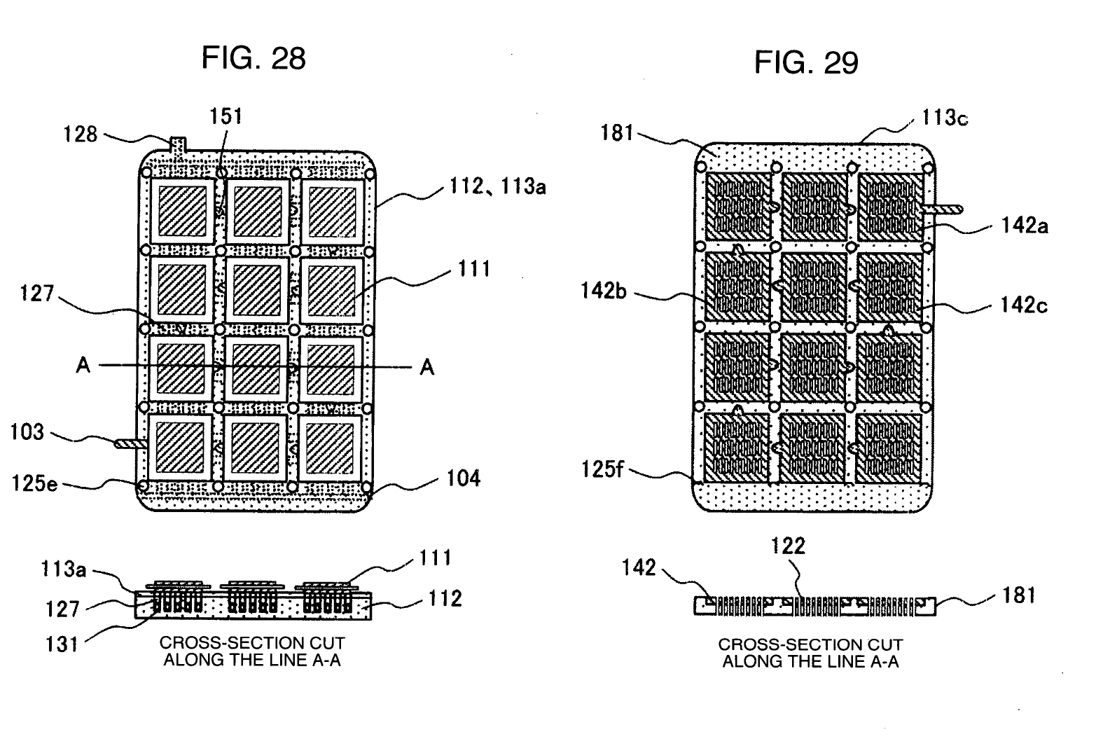

FIG. 28 illustrates an assembled MEA layout and sectional structure cut along the line A-A. The DMFC has a power-generation section (16 by 18 mm in size) and a total of 12 MEAs (each 22 by 24 mm in size) on the surface slit section of the anode terminal plate 113a integrated with the fuel chamber 112. The fuel chamber 112 contains gas/liquid separation modules each combined with the gas/liquid separation tube 131, each module being inserted into the fuel distribution groove 127, also provided within the chamber 112. The gas/liquid separation module is connected to the fuel supply port 104 at one end. The fuel distribution groove 127 is connected, at one end, to the fuel supply tube positioned on the circumference of the fuel chamber 112. The current collector (not shown in FIG. 28) is mounted on the external surface of the anode terminal plate 113a in such a way that the external surfaces of the anode terminal plate 113a and current collector form the same plane, and is provided with the interconnectors 151 and output terminal 103, the former for connecting single cells to each other in series.

The current collector is made of a 0.3 mm thick titanium plate, and coated with an about 0.1 μm thick gold layer on the portion coming into contact with the electrode, which is deposited by vacuum evaporation after the collector surface is cleaned. FIG. 29 illustrates the cathode terminal plate 113c structure for fixing MEAs and connecting the cells to each other in series. For the cathode terminal plate 113c, a 2.5 mm thick epoxy resin plate reinforced with glass fibers is used as the base board 181. The plate surface supports the current collectors 142a, 142b and 142c of 0.3 mm thick titanium plate, bonded to the surface by an epoxy resin, where these collectors are coated with gold in the same manner as described above. The base board 181 and current collectors 140 are provided with the slits 122 for diffusing air, and bonded to each other in such a way that they are in communication with each other.

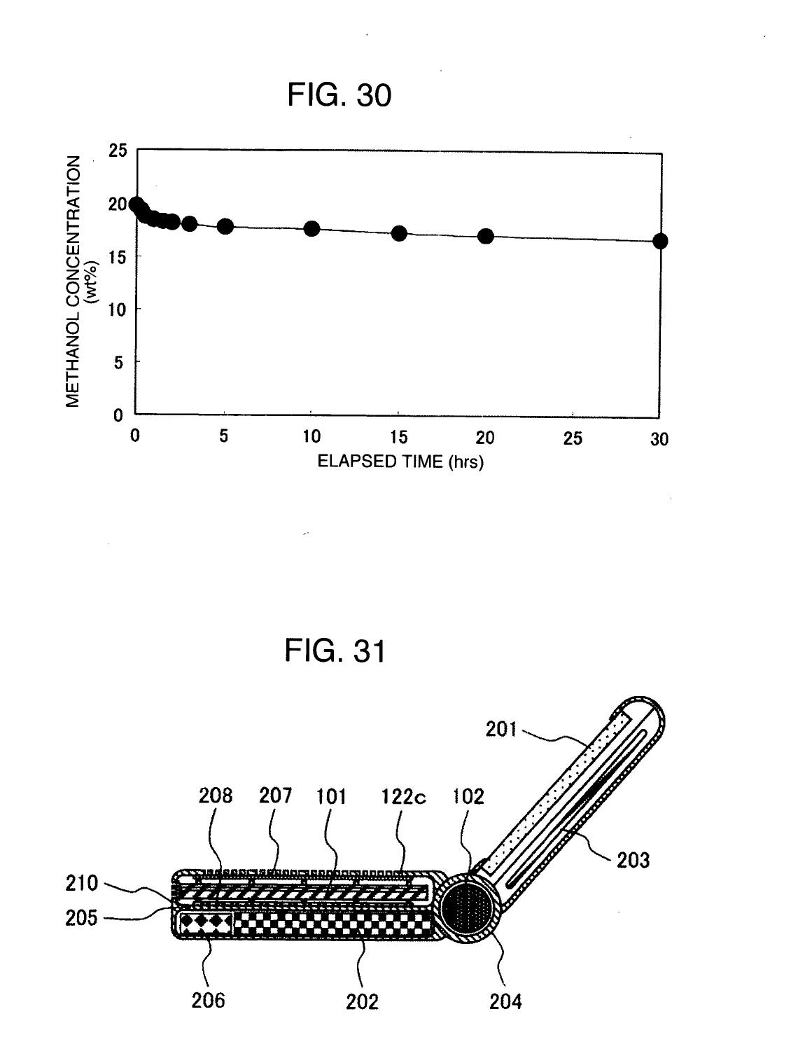

The power source thus prepared is 115 by 90 by 9 mm in size. The MEA which constitutes the power generation section of the DMFC assembled in the power source allows the DMFC to produce a higher output than a conventional DMFC by use of the catalyst described in EXAMPLE 1. FIG. 30 presents a temporal change of methanol concentration in the fuel chamber 112, where the aqueous methanol solution is kept at 20% by weight in the fuel cartridge tank 102. As shown, a power system can produce a stable output without a mechanism of sensing and controlling liquid fuel concentration in a fuel cell, when an electrolyte membrane having a liquid fuel permeability of 12 mA/cm² is used and a make-up liquid fuel is kept at a concentration of 20% by weight or more, because the liquid fuel can have an essentially constant concentration after a lapse of certain time, and steam is prevented from being condensed by natural aspiration on the anode.

On the other hand, a power system in which the MEA (4) prepared in COMPARATIVE EXAMPLE is used in place of the MEA (13) cannot stably produce an output, because of immediately decreased liquid fuel concentration. Moreover, steam is condensed by natural aspiration on the anode to cause oxygen shortage and unstable output. Therefore, removal of condensate is prerequisite for the power system.

FIG. 31 illustrates one embodiment of portable information terminal structure in which DMFC prepared in EXAMPLE 5 is used. The terminal has a portion which includes the display 201 with an integrated touch-panel type input device and built-in antenna 203. It also has a portion which includes the fuel cell 101, main board 202 and lithium ion secondary battery 206, where the main board 202 supports electronic devices (e.g., processor, volatile memory, involatile memory, power controller, hybrid controller for the fuel cell and secondary battery, and fuel monitor), and electronic circuits. It has a foldable structure with these portions connected to each other by the hinge 204 provided with a cartridge holder, which also works as a holder for the fuel cartridge tank 102. The section in which the power source is mounted is divided into two parts by the diaphragm 205, with the main board 202 and lithium ion secondary battery 206 contained in the lower section, and the fuel cell 101 in the upper section. The terminal also has the slits 122c. Those slits 122c provided on and side of the box 210 are for diffusing air and cell exhaust gases. Each of those provided in the box is equipped with the air filter 207 on the surface, and diaphragm is equipped on the surface with the water-absorptive member 208 which can be quickly dried. Any material can be used for the air filter, so long as it can well diffuse gases while preventing inflow of dust. Some of the suitable materials are single yarns of synthetic resin formed into a mesh or woven, because they are serviceable without being clogged. This embodiment adopts single yarns of highly water-repellent polytetrafluoroethylene formed into a mesh.

The MEA which constitutes the power generation section of the DMFC assembled in the portable information terminal allows the DMFC to produce a higher output than a conventional DMFC by use of the catalyst described in EXAMPLE 1, and hence can increase a maximum output which the terminal requires.

It should be further understood by those skilled in the art that although the foregoing description has been made on embodiments of the invention, the invention is not limited thereto and various changes and modifications may be made without departing from the spirit of the invention and the scope of the appended claims.

### INDUSTRIAL APPLICABILITY

The compact fuel cell power system of the present invention contributes to spread of fuel cells.

1. A fuel cell power system equipped with a plurality of electrically connected single cells, each having an anode for oxidizing a liquid fuel supplied to the cells and having a cathode for reducing oxygen with an electrolyte membrane between the anode and the cathode, wherein the electrolyte membrane has a liquid fuel permeability of 0.02 to 70 mA/cm² and the liquid fuel having a concentration of 15% by weight or more is supplied to generate a power.

2. The fuel cell power system according to claim 1, wherein the liquid fuel having a concentration of 15 to 60% by weight is supplied.

3. The fuel cell power system according to claim 1, wherein the electrolyte membrane has an ion conductivity of 0.005 to 0.2 S/cm.

4. The fuel cell power system according to claim 1, wherein the electrolyte membrane is a hydrocarbon-based electrolyte membrane.

5. The fuel cell power system according to claim 4, wherein the hydrocarbon-based electrolyte membrane is of a sulfoalkylated aromatic hydrocarbon.

6. The fuel cell power system according to claim 1, wherein the liquid fuel is supplied by a cartridge.

7. A method for operating a fuel cell power system equipped with a plurality of electrically connected single cells, each having an anode for oxidizing a liquid fuel supplied to the cells and having a cathode for reducing oxygen with an electrolyte membrane between the anode and the cathode to generate a power, wherein the electrolyte membrane has a liquid fuel permeability of 0.02 to 70 mA/cm² and the liquid fuel having a concentration of 15 to 60% by weight is supplied.

8. The method according to claim 7, wherein water produced on the cathode is removed by a natural aspiration.

9. A fuel cell power system equipped with an anode and a cathode with an electrolyte membrane between the anode and the cathode, holding a liquid fuel having a concentration of 90% by weight or more, mixing water produced on the cathode with the liquid fuel, and having a liquid fuel supply system which continuously supplies the liquid fuel to the anode, wherein the electrolyte membrane has a liquid fuel permeability of 0.02 to 70 mA/cm².

10. The fuel cell power system according to claim 9, wherein the liquid fuel is adjusted to have a concentration of 15 to 60% by weight just anterior to the electrolyte membrane.

11. An electronic device having a fuel cell power system equipped with a plurality of electrically connected single cells, each running on a liquid fuel and having an anode for oxidizing the liquid fuel and having a cathode for reducing oxygen with an electrolyte membrane between the anode and the cathode, wherein the electrolyte membrane has a liquid fuel permeability of 0.02 to 70 mA/cm² and the liquid fuel having a concentration of 15% by weight or more is supplied to generate a power.

12. The electronic device according to claim 11 which is a portable information terminal, mobile laptop personal computer, cellular phone or camcoder.

13. A portable power source for outdoor use in which the fuel cell power system according to claim 1 is incorporated.

14. An automobile which is equipped with the fuel cell power system according to claim 1.
